(19) United States
(12) Patent Application Publication
(10) Pub. No.: US 2026/0268065 A1
(43) Pub. Date: Sep. 10, 2026

(54) INFORMATION PROCESSING DEVICE AND INFORMATION PROCESSING METHOD

(71) Applicant: SEMICONDUCTOR ENERGY LABORATORY CO., LTD., Atsugi-shi (JP)

(72) Inventors: Junpei MOMO, Kanagawa (JP); Kazuki HIGASHI, Kanagawa (JP); Kengo AKIMOTO, Kanagawa (JP); Hiroki HOSOSHIMA, Kanagawa (JP); Aoi NAKAMURA, Kanagawa (JP); Jonatan HYBERG, Levertinsgatan (SE)

(21) Appl. No.: 19/551,721

(22) Filed: Feb. 27, 2026

(30) Foreign Application Priority Data
Mar. 7, 2025 (JP) 2025-036025

(51) Int. Cl. G06F 40/166; G06F 40/40

(52) U.S. Cl. CPC G06F 40/166; G06F 40/40

(57) ABSTRACT

After first and second documents are received, a text generation language model generates a summary sentence of the second document. A difference presentation language model presents a difference in the first document from the summary sentence. When the difference is not appropriate, the difference presentation language model is made to present a difference again on the basis of a first instruction document created by a user. When the difference is appropriate, the difference presentation language model is made to confirm that the difference is absent in the second document. The difference presentation language model is fine-tuned using a plurality of data points each including an order sentence, two learning texts, and a learning response sentence. Among the plurality of data points, some of the learning response sentences show the absence of a difference between the two learning texts, and the rest show a difference between the two learning texts.

### BACKGROUND OF THE INVENTION

### 1. Field of the Invention

One embodiment of the present invention relates to an information processing device. Another embodiment of the present invention relates to an information processing method using an information processing device. Another embodiment of the present invention relates to an information processing system including an information processing device.

Note that one embodiment of the present invention is not limited to the above technical field. The technical field of one embodiment of the invention disclosed in this specification and the like relates to an object, a method, or a manufacturing method. Alternatively, one embodiment of the present invention relates to a process, a machine, manufacture, or a composition of matter. Thus, more specifically, examples of the technical field of one embodiment of the present invention disclosed in this specification include an information processing device, a semiconductor device, a memory device, a driving method thereof, and a manufacturing method thereof.

### 2. Description of the Related Art

Documents related to patent applications, e.g., patent specifications need to be written to contain a technical concept while satisfying the written description requirement. This requires high-level knowledge and skill related to an intellectual property and is difficult for an inexperienced person. Patent Document 1 discloses a method for automatically complementing the description of a patent specification.

In recent years, language models using artificial neural networks (ANNs, hereinafter also simply referred to as neural networks) have been actively developed, and large language models (LLMs) in particular have attracted attention. A large language model is a natural language processing model learned using a large amount of data. With a large language model, a communication model that gives an answer to a user's instruction can be achieved, for example. In Non-Patent Document 1, Generative Pre-Trained Transformer 4 (GPT-4, registered trademark) is disclosed as a large language model, and ChatGPT is disclosed as a communication model. Other examples of large language models include LaMDA (Language Model for Dialogue Applications), PaLM (Pathways Language Model), Llama2, and Llama3.

### REFERENCES

[Patent Document 1] Japanese Published Patent Application No. 2022-24112
[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

A patent specification needs to satisfy the description requirement while differentiating the invention from an invention disclosed in a prior art literature, for example. This requires sufficient understanding of the invention related to the application and the invention disclosed in the prior art literature, deep knowledge of a Patent Act, and the like. Furthermore, a slight difference in description of a patent specification might greatly affect the scope of patent rights, for example. Thus, the description of a patent specification requires meticulous attention. Accordingly, a patent specification needs to be prepared with a large amount of time and effort and is difficult for an inexperienced person to prepare in a short time, for example. It is sometimes difficult for an inventor itself to prepare a patent specification in between tasks such as research and development, for example.

In view of the above, an object of one embodiment of the present invention is to provide an information processing device, an information processing method, and an information processing system that assist preparation of a document related to an intellectual property. Another object of one embodiment of the present invention is to provide an information processing device, an information processing method, and an information processing system that can prepare a document related to an intellectual property in a short time. Another object of one embodiment of the present invention is to provide an information processing device, an information processing method, and an information processing system that can reduce the workload on a user in preparing a document related to an intellectual property. Another object of one embodiment of the present invention is to provide an information processing device, an information processing method, and an information processing system that can prepare a highly complete document related to an intellectual property.

Another object of one embodiment of the present invention is to provide an information processing device, an information processing method, and an information processing system that are highly convenient and useful. Another object of one embodiment of the present invention is to provide a novel information processing device, a novel information processing method, and a novel information processing system.

Note that the description of these objects does not preclude the existence of other objects. One embodiment of the present invention does not necessarily achieve all of these objects. Those skilled in the art can find and extract other objects from the description of the specification, the drawings, the claims, and the like.

One embodiment of the present invention is an information processing method, which includes receiving a first document and a second document; obtaining a summary sentence of the second document with use of a first language model; and obtaining a difference in the first document from the summary sentence with use of a second language model. The second language model is learned using a first data point and a second data point. The first data point includes a first order sentence, a first learning text, a second learning text, and a first learning response sentence. The second data point includes the first order sentence, a third learning text, a fourth learning text, and a second learning response sentence. The first learning response sentence shows a difference in the first learning text from the second learning text. The second learning response sentence shows the absence of a difference in the third learning text from the fourth learning text.

Alternatively, the information processing method in the above embodiment may further include presenting the difference from the summary sentence and receiving a determination of whether the difference from the summary sentence is appropriate; when the difference from the summary sentence is not appropriate, receiving an instruction document, obtaining again a difference in the first document from the summary sentence on the basis of the instruction document with use of the second language model, and then receiving again a determination of whether the difference from the summary sentence is appropriate; and when the difference from the summary sentence is appropriate, confirming the absence of the difference from the summary sentence in the second document with use of the second language model. The second language model may be learned using a third data point and a fourth data point. The third data point may include a second order sentence, a fifth learning text, a sixth learning text, a first learning instruction document, and a third learning response sentence. The fourth data point may include the second order sentence, a seventh learning text, an eighth learning text, a second learning instruction document, and a fourth learning response sentence. The third learning response sentence may present a difference, which is based on the first learning instruction document, in the fifth learning text from the sixth learning text. The fourth learning response sentence may show that the second learning instruction document is not appropriate as a material for determining a difference in the seventh learning text from the eighth learning text.

Another embodiment of the present invention is an information processing method including a first step, a second step, a third step, a fourth step, a fifth step, a sixth step, a seventh step, an eighth step, a ninth step, a tenth step, an eleventh step, and a twelfth step. In the first step, a first document and a second document are received. In the second step, a first prompt for generating a summary sentence of the second document is created and transmitted to a first language model. In the third step, a second prompt for presenting a difference in the first document from the summary sentence is created and transmitted to a second language model. In the fourth step, a determination of whether the difference is appropriate is received. When the difference is not appropriate, a first instruction document is received in the fifth step, a third prompt for presenting again a difference in the first document on the basis of the first instruction document is created and transmitted to the second language model in the sixth step, and then the fourth step is performed again. When the difference is appropriate, a fourth prompt for confirming the absence of the difference in the second document is created and transmitted to the second language model in the seventh step. When the second document contains at least part of the difference, the fifth step is performed again. When the difference is absent in the second document, a fifth prompt for generating a third document on the basis of the second document and the difference is created and transmitted to the first language model in the eighth step. In the ninth step, a determination of whether the third document needs modification is received. When the modification is needed, a second instruction document is received in the tenth step, a sixth prompt for modifying the third document on the basis of the second instruction document is created and transmitted to the first language model in the eleventh step, and then the ninth step is performed again. When the modification is not needed, the third document is output in the twelfth step. The second language model is learned using a first data point and a second data point. The first data point includes a first order sentence, a first learning text, a second learning text, and a first learning response sentence. The second data point includes the first order sentence, a third learning text, a fourth learning text, and a second learning response sentence. The first learning response sentence shows a difference in the first learning text from the second learning text. The second learning response sentence shows the absence of a difference in the third learning text from the fourth learning text.

Alternatively, the information processing method in the above embodiment may further include a thirteenth step, a fourteenth step, and a fifteenth step. When the difference from the summary sentence is absent in the second document, before the eighth step, a seventh prompt for determining whether information for generating the third document is insufficient may be created and transmitted to a third language model in the thirteenth step. When the information is insufficient, additional information may be received in the fourteenth step and then the seventh prompt may be created again to include the additional information and transmitted to the first language model in the fifteenth step. When the information is not insufficient, the eighth step may be performed again. The third language model may be learned using a fifth data point and a sixth data point. The fifth data point may include a third order sentence, a ninth learning text, a tenth learning text, and a fifth learning response sentence. The sixth data point may include the third order sentence, an eleventh learning text, a twelfth learning text, and a sixth learning response sentence. The fifth learning response sentence may present missing information for generating a document on the basis of the ninth learning text and the tenth learning text. The sixth learning response sentence may show that information for generating a document on the basis of the eleventh learning text and the twelfth learning text is not insufficient.

Another embodiment of the present invention is an information processing device including a reception unit, an output unit, and a processing unit. The reception unit has a function of receiving a first document, a second document, a first instruction document, and a second instruction document. The output unit has a function of supplying a first prompt, a fifth prompt, and a sixth prompt to a first language model and supplying a second prompt, a third prompt, and a fourth prompt to a second language model. The output unit has a function of outputting a third document. The processing unit has a function of performing processing of creating the first prompt for generating a summary sentence of the second document; processing of creating the second prompt for presenting a difference in the first document from the summary sentence; processing of making a user determine whether the difference is appropriate; processing of, when the difference is not appropriate, creating the third prompt for presenting again a difference in the first document on the basis of the first instruction document; processing of, when the difference is appropriate, creating the fourth prompt for confirming the absence of the difference in the second document; processing of, when the second document contains at least part of the difference, creating the third prompt on the basis of the first instruction document; processing of, when the difference is absent in the second document, creating the fifth prompt for generating the third document on the basis of the second document and the difference; processing of making the user determine whether the third document needs modification; and processing of, when the modification is needed, creating the sixth prompt for modifying the third document on the basis of the second instruction document. The second language model is learned using a first data point and a second data point. The first data point includes a first order sentence, a first learning text, a second learning text, and a first learning response sentence. The second data point includes the first order sentence, a third learning text, a fourth learning text, and a second learning response sentence. The first learning response sentence shows a difference in the first learning text from the second learning text. The second learning response sentence shows the absence of a difference in the third learning text from the fourth learning text.

Alternatively, in the above embodiment, the second language model may be learned using a third data point and a fourth data point. The third data point may include a second order sentence, a fifth learning text, a sixth learning text, a first learning instruction document, and a third learning response sentence. The fourth data point may include the second order sentence, a seventh learning text, an eighth learning text, a second learning instruction document, and a fourth learning response sentence. The third learning response sentence may present a difference, which is based on the first learning instruction document, in the fifth learning text from the sixth learning text. The fourth learning response sentence may show that the second learning instruction document is not appropriate as a material for determining a difference in the seventh learning text from the eighth learning text.

Alternatively, in the above embodiment, the first instruction document may include at least one of an instruction to modify the first document and a comment on the difference from the summary sentence. The second instruction document may include at least one of an instruction to modify the third document and a comment on the third document.

Alternatively, in the above embodiment, the reception unit may have a function of receiving additional information. The output unit may have a function of supplying a seventh prompt to a third language model. The processing unit may have a function of performing processing of, when the difference from the summary sentence is absent in the second document, creating the seventh prompt for determining whether information for generating the third document is insufficient; processing of, when the information is insufficient, creating again the seventh prompt so that the seventh prompt includes the additional information; and processing of, when the information is not insufficient, creating the fifth prompt. The third language model may be learned using a fifth data point and a sixth data point. The fifth data point may include a third order sentence, a ninth learning text, a tenth learning text, and a fifth learning response sentence. The sixth data point may include the third order sentence, an eleventh learning text, a twelfth learning text, and a sixth learning response sentence. The fifth learning response sentence may present missing information for generating a document on the basis of the ninth learning text and the tenth learning text. The sixth learning response sentence may show that information for generating a document on the basis of the eleventh learning text and the twelfth learning text is not insufficient.

Alternatively, in the above embodiment, the first document and the second document may each be a document describing a creation.

Alternatively, in the above embodiment, the second document may be a patent literature or a utility model literature. The third document may be a specification belonging to a patent application or a specification belonging to a utility model registration application.

One embodiment of the present invention can provide an information processing device, an information processing method, and an information processing system that assist preparation of a document related to an intellectual property. One embodiment of the present invention can provide an information processing device, an information processing method, and an information processing system that can prepare a document related to an intellectual property in a short time. One embodiment of the present invention can provide an information processing device, an information processing method, and an information processing system that can reduce the workload on a user in preparing a document related to an intellectual property. One embodiment of the present invention can provide an information processing device, an information processing method, and an information processing system that can prepare a highly complete document related to an intellectual property.

One embodiment of the present invention can provide an information processing device, an information processing method, and an information processing system that are highly convenient and useful. One embodiment of the present invention can provide a novel information processing device, a novel information processing method, and a novel information processing system.

Note that the description of these effects does not preclude the existence of other effects. One embodiment of the present invention does not necessarily have all of these effects. Those skilled in the art can find and extract other effects from the description of the specification, the drawings, the claims, and the like.

### BRIEF DESCRIPTION OF THE DRAWINGS

FIG. 1 is a schematic view showing an example of an information processing system.

FIG. 2 is a block diagram showing an example of an information processing system.

FIG. 3 is a flow diagram showing an example of an information processing method.

FIG. 4 is a flow diagram showing an example of an information processing method.

FIG. 5 is a schematic view showing an example of an information processing method.

FIGS. 6A and 6B are schematic views showing an example of an information processing method.

FIGS. 7A and 7B are schematic views showing an example of an information processing method.

FIGS. 8A and 8B are schematic views showing an example of an information processing method.

FIGS. 9A and 9B are schematic views showing an example of an information processing method.

FIG. 10 is a flow diagram showing an example of an information processing method.

FIGS. 11A and 11B are schematic views showing an example of an information processing method.

FIG. 12 is a flow diagram showing an example of an information processing method.

FIG. 13 is a schematic view showing an example of an information processing method.

### DETAILED DESCRIPTION OF THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Accordingly, the present invention should not be construed as being limited to the description in the following embodiments. Note that in structures of the invention described below, the same portions or portions having similar functions are denoted by the same reference numerals in different drawings, and the description thereof is not repeated.

Although a block diagram in which components are classified by their functions and shown as independent blocks is shown in the drawing attached to this specification, it is difficult to completely separate actual components according to their functions and one component can relate to a plurality of functions.

In this specification and the like, the terms “first” and “second” are sometimes used for easy understanding of the technical contents or identification of components. Thus, the terms “first” and “second” do not limit the number of components. The terms “first” and “second” do not limit the order of components. In addition, the terms such as “first” and “second” or identification numerals used in this specification do not correspond to the terms or the identification numerals in the scope of claims of this application in some cases.

### EMBODIMENT

This embodiment will describe an information processing system of one embodiment of the present invention. This embodiment will also describe an information processing device included in the information processing system and an information processing method using the information processing system.

One embodiment of the present invention relates to an information processing system that generates a third document on the basis of first and second documents with use of a language model. The first and second documents are each a document describing a creation, e.g., a document showing an invention or a device. Specifically, the first document can be a document describing a creation to be filed. The second document can be a prior art literature, e.g., a patent literature or a utility model literature. The third document can be a patent application document or a utility model application document, e.g., a specification belonging to a patent application or a specification belonging to a utility model registration application. Here, a specification belonging to a patent application and a specification belonging to a utility model registration application are collectively and simply referred to as a specification. Note that the second and third documents may each be a paper, for example. In this case, the first document can be a document showing research results.

An invention and a device are each a creation of a technical concept utilizing the natural law. Thus, the term “creation” refers to both the invention and the device. Here, the invention is protected by a Patent Act. The device is protected by a Utility Model Act.

In the information processing method of one embodiment of the present invention, first, a text generation language model generates a summary sentence of the second document. A difference presentation language model presents a difference in the first document from the summary sentence of the second document. Specifically, the difference can be a feature, e.g., a technical feature that is not described in the summary sentence of the second document among features described in the first document.

The difference presentation language model has been fine-tuned using a plurality of data points each including an order sentence, two learning texts, and a learning response sentence. The order sentence includes an order to present a difference between the two learning texts. One of the two learning texts corresponds to the above-described first document, and the other corresponds to the summary sentence of the above-described second document. Among the plurality of data points, some of the learning response sentences show the absence of a difference between the two learning texts, and the rest show a difference between the two learning texts.

Compared with the case without fine-tuning, the case of performing fine-tuning on the difference presentation language model can effectively inhibit occurrence of hallucination. Performing fine-tuning can inhibit, in particular, the difference presentation language model from presenting a difference in the first document from the summary sentence of the second document even though there is no difference. Accordingly, even a person inexperienced in the intellectual property business can prepare a highly complete specification, for example.

In this specification and the like, hallucination refers to a phenomenon where artificial intelligence (AI) generates baseless information.

A user of the information processing system determines whether the difference is appropriate. In the case where the difference is not appropriate, the user of the information processing system creates a first instruction document. The difference presentation language model presents again a difference in the first document from the summary sentence of the second document on the basis of the first instruction document. The first instruction document can include at least one of an instruction to modify the first document and a comment on the difference, for example. Here, the comment on the difference can be an opinion on the difference, for example. In the case where the user of the information processing system considers that there is another difference in the first document from the second document in addition to the presented difference, for example, the first instruction document can include a text showing this idea. Moreover, in the case where the user of the information processing system considers that the second document contains at least part of the presented difference, the first instruction document can include a text showing this idea.

In the case where the difference is appropriate, the difference presentation language model confirms the absence of the difference in the second document. The confirmation result is presented to the user of the information processing system.

In the case where the second document contains at least part of the difference, the user of the information processing system creates the first instruction document as in the case where the difference is not appropriate. In the case where the difference is absent in the second document, the text generation language model generates the third document on the basis of the second document and the difference.

The user of the information processing system checks the third document. For example, in the case where the third document needs modification, the user of the information processing system creates a second instruction document. The text generation language model modifies the third document on the basis of the second instruction document. Here, the second instruction document may include a comment on a matter described in the third document. The comment can be a question about a matter described in the third document, for example. In this case, the text generation language model can generate an answer to the comment. Note that the text generation language model may perform only generation of an answer to the comment and does not necessarily perform modification of the third document. When the third document is completed and does not need modification, the third document is output. For example, the third document is supplied to an information terminal of the user of the information processing system.

In the above-described manner, with use of the information processing system of one embodiment of the present invention, the third document can be generated on the basis of the difference in the first document from the second document. A specification related to the creation described in the first document can be prepared so that a technical feature not disclosed in a prior art literature is emphasized in the specification, for example. As described above, the information processing system of one embodiment of the present invention can assist preparation of a document related to an intellectual property, e.g., a specification. Thus, with use of the information processing system of one embodiment of the present invention, even a person inexperienced in the intellectual property business can prepare a document related to an intellectual property, e.g., a specification in a short time. In addition, it is possible to reduce the workload on a user in preparing a document related to an intellectual property, e.g., a specification.

Moreover, in the information processing system of one embodiment of the present invention, owing to the first instruction document created by the user, the difference presentation language model can present a difference in the first document from the second document a plurality of times. Specifically, the difference presentation language model can present the difference a plurality of times on the basis of the contents of the first instruction document. Furthermore, in the information processing system of one embodiment of the present invention, owing to the second instruction document created by the user, the text generation language model can modify the third document at least once. Thus, the user of the information processing system of one embodiment of the present invention can prepare the third document in an interactive manner. Accordingly, even a person inexperienced in the intellectual property business can prepare a highly complete specification, for example.

### <Structure Example 1 of Information Processing System>

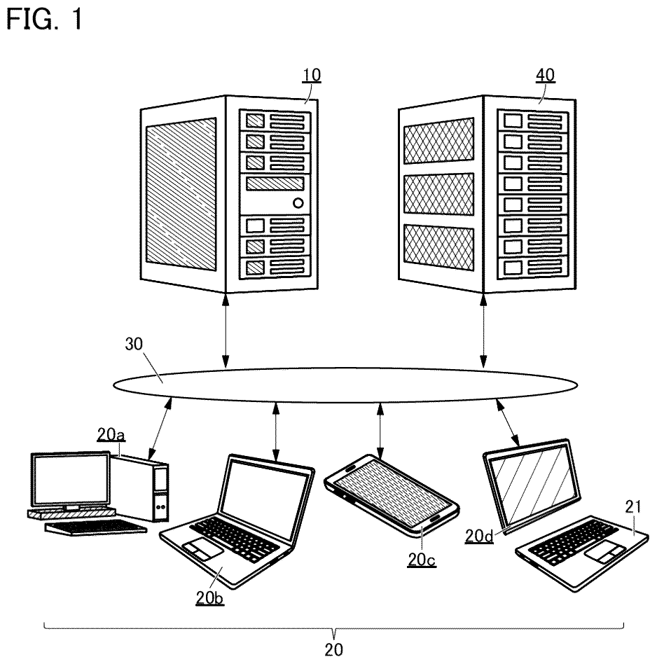

FIG. 1 is a schematic view showing a structure example of the information processing system of one embodiment of the present invention. The information processing system of one embodiment of the present invention includes an information processing device 10 and an information processing device 40. The information processing device 10 and the information processing device 40 are connected to each other via a network 30 and can transmit and receive data.

The information processing device 40 has a function of performing processing using a language model. The language model has a function of generating a response sentence on the basis of a prompt. The prompt is regarded as an input sentence for causing the language model to perform an intended operation. The language model divides the prompt into tokens (tokenization) and performs processing. As the tokenization, word tokenization, character tokenization, or subword tokenization can be performed.

The prompt is supplied from the information processing device 10 to the information processing device 40, for example. The response sentence generated by the language model is supplied from the information processing device 40 to the information processing device 10, for example. Note that the information processing device 10 may have a function of performing processing using a language model.

The information processing system of one embodiment of the present invention may be configured such that the user can directly operate the information processing device 10 to input a document or the like, or may be configured such that the user can input a document or the like with an information terminal 20 connected to the information processing device 10 via the network 30, as illustrated in FIG. 1.

Structure examples of the information processing device 10, the information processing device 40, the information terminal 20, and the network 30 are described below.

### <<Structure Example of Information Processing Device 10>>

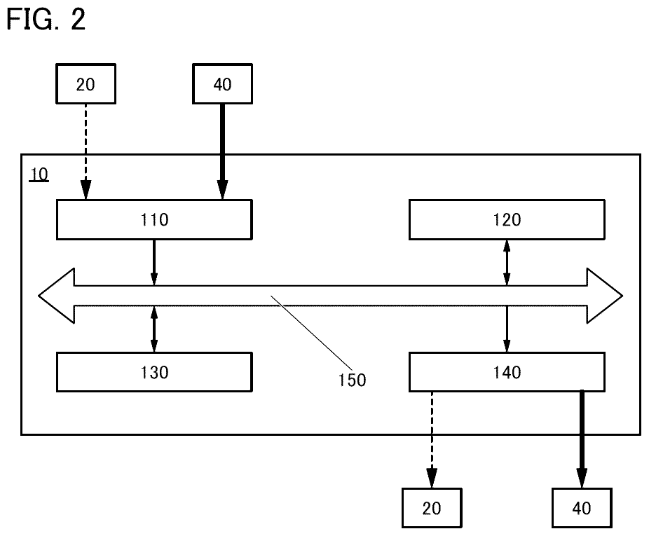

FIG. 2 is a block diagram showing a structure example of the information processing device 10. The information processing device 10 includes a reception unit 110, a memory unit 120, a processing unit 130, an output unit 140, and a transmission path 150. FIG. 2 also illustrates the information terminal 20 and the information processing device 40.

### [Reception Unit 110]

The reception unit 110 has a function of receiving data from the outside of the information processing device 10. The reception unit 110 has a function of receiving data representing a document, for example, from the information terminal 20. The reception unit 110 has a function of receiving data representing a response sentence, for example, from the information processing device 40.

The reception unit 110 has a function of supplying the received data to one or both of the memory unit 120 and the processing unit 130 via the transmission path 150. As the reception unit 110, a device such as a wired communication port, a wireless communication port, or an optical communication port can be used, for example.

### [Memory Unit 120]

The memory unit 120 has a function of storing a program to be executed by the processing unit 130. The memory unit 120 may have a function of storing data (e.g., an arithmetic result, an analysis result, and an inference result) created by the processing unit 130, data received by the reception unit 110, and the like.

The memory unit 120 may include a database. The information processing device 10 may include another database different from the memory unit 120. The information processing device 10 may have a function of extracting data from a database placed outside the memory unit 120, the information processing device 10, or the information processing system. Alternatively, the information processing device 10 may have a function of extracting data from both of its own database and an external database.

One or both of a storage and a file server can be used in the memory unit 120. In addition, a database that stores paths of files retained in the file server can be used as the memory unit 120.

### [Processing Unit 130]

The processing unit 130 has a function of performing processing such as arithmetic processing, analysis, and inference with use of data supplied from one or both of the reception unit 110 and the memory unit 120. The processing unit 130 can supply created data (e.g., an arithmetic result, an analysis result, or an inference result) to one or both of the memory unit 120 and the output unit 140. The processing unit 130 has a function of creating a prompt. Note that the processing unit 130 may have a function of performing processing using a language model.

The processing unit 130 has a function of obtaining data from the memory unit 120. The processing unit 130 may have a function of storing or registering data in the memory unit 120.

### [Output Unit 140]

The output unit 140 has a function of outputting at least one of an arithmetic result, an analysis result, and an inference result in the processing unit 130 to the outside of the information processing device 10. As the output unit 140, a device such as a wired communication port, a wireless communication port, or an optical communication port can be used, for example.

For example, the output unit 140 has a function of supplying data representing a prompt or the like to the information processing device 40. The output unit 140 also has a function of supplying data representing a document or the like to the information terminal 20.

### [Transmission Path 150]

The transmission path 150 has a function of transmitting data. Data transmission and reception among the reception unit 110, the memory unit 120, the processing unit 130, and the output unit 140 can be performed through the transmission path 150. As the transmission path 150, a bus line on a motherboard, a wired communication cable, or an optical communication cable can be used, for example.

### <<Structure Example of Information Processing Device 40>>

The information processing device 40 can process the received data and transmit the processing result. For example, the information processing device 40 can perform arithmetic processing or the like using data supplied from the information processing device 10. The information processing device 40 can supply the processing result to the information processing device 10. Accordingly, arithmetic processing loads on the information processing device 10 can be reduced.

The information processing device 40 can perform processing using a language model, as described above. For example, the information processing device 40 can perform processing using a language model such as Bidirectional Encoder Representations from Transformers (BERT) or Text-to-Text Transfer Transformer (T5). Furthermore, the information processing device 40 can perform processing using a language-model-based model (a text generation model, a conversation model, or the like).

The language model generates a response sentence on the basis of a prompt, as described above. For example, a prompt created by the processing unit 130 is supplied to the language model of the information processing device 40 through the output unit 140. The response sentence generated by the language model is supplied to one or both of the memory unit 120 and the output unit 140, for example, through the reception unit 110.

Furthermore, the information processing device 40 can perform processing using a general-purpose language processing model capable of performing a variety of natural language processing tasks.

The information processing device 40 is a large computer such as a server computer or a supercomputer. The information processing device 40 preferably has a function of a parallel computer. When the information processing device 40 is used as a parallel computer, large-scale computation necessary for AI learning and inference can be performed, for example.

Note that the information processing device 40 is a computer having higher processing power than the information processing device 10. For example, in the case where both the information processing device 10 and the information processing device 40 have a function of a parallel computer, the information processing device 40 having higher processing power than the information processing device 10 enables larger-scale computation. For another example, in the case where both the information processing device 10 and the information processing device 40 can perform processing using a language-model-based model, the information processing device 40 can perform processing using a larger-scale model as compared with the information processing device 10.

Note that a service provider does not necessarily have its own information processing device 40. For example, a service provider can utilize part of the service that another company or the like provides using the information processing device 40.

### <<Structure Example of Information Terminal 20>>

The information terminal 20 can receive data input by the user of the information processing system of one embodiment of the present invention. The information terminal 20 can present data output from the information processing system of one embodiment of the present invention to the user by displaying the data on a display portion of the information terminal 20. Alternatively, the information terminal 20 can present data output from the information processing system of one embodiment of the present invention to the user by printing the data by a printing unit included in the information terminal 20.

The information terminal 20 can supply data received from the user to the information processing device 10. The information terminal 20 can present data supplied from the information processing device 10 to the user.

The information terminal 20 can supply data created on the basis of data received from the user to the information processing device 10. The information terminal 20 can present data created on the basis of data supplied from the information processing device 10 to the user.

Dedicated application software and a web browser, for example, are installed on the information terminal 20. The user can access the information processing device 10 through the dedicated application software, the web browser, or the like. Thus, the user can enjoy a service based on the information processing system of one embodiment of the present invention by using a computer whose processing power is lower than that of the information processing device 10, for example, as the information terminal 20.

The information terminal 20 can also be referred to as a client computer or the like. Any type of the information terminal 20 is an information terminal used by the user of the information processing system of one embodiment of the present invention.

For example, a desktop computer 20a, a laptop computer 20b, a smartphone 20c, or a tablet computer 20d can be used as the information terminal 20. Note that the tablet computer 20d can also be used as a laptop computer when connected to a housing 21 including a keyboard.

### <<Network 30>>

The network 30 connects the information processing device 10 and the information processing device 40. The network 30 also connects a plurality of the information terminals 20 and the information processing device 10. Thus, input data and processed data can be transmitted and received between the information processing devices 10 and 40 and between the information terminals 20 and the information processing device 10. Furthermore, information processing loads can be dispersed.

An information processing method using the information processing system illustrated in FIG. 1 and FIG. 2 is described below. Specifically, a method for operating the information processing device 10 is described. In the information processing method of one embodiment of the present invention, the third document is generated on the basis of the first and second documents with use of a language model.

### <Information Processing Method 1>

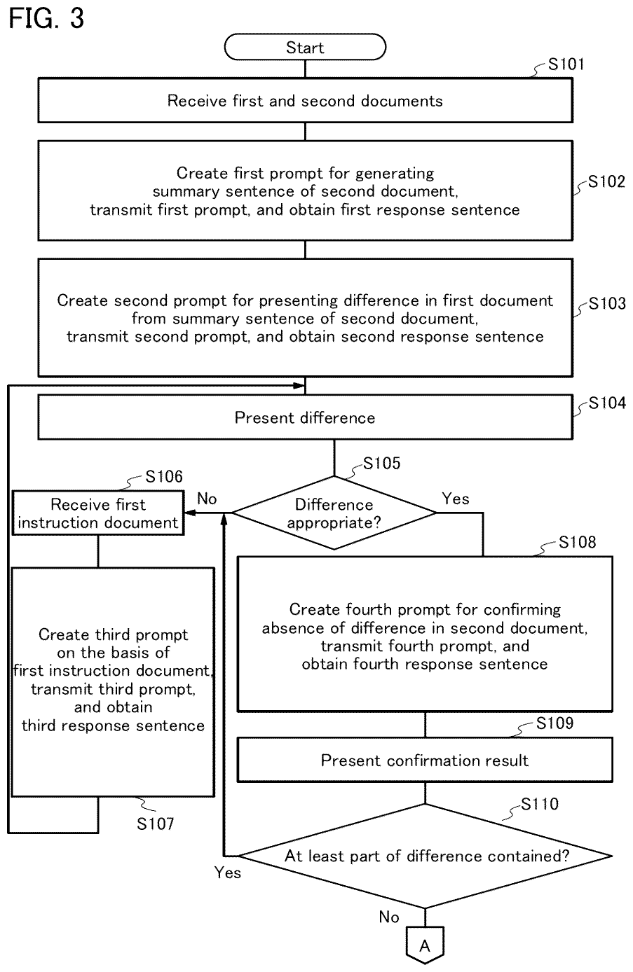

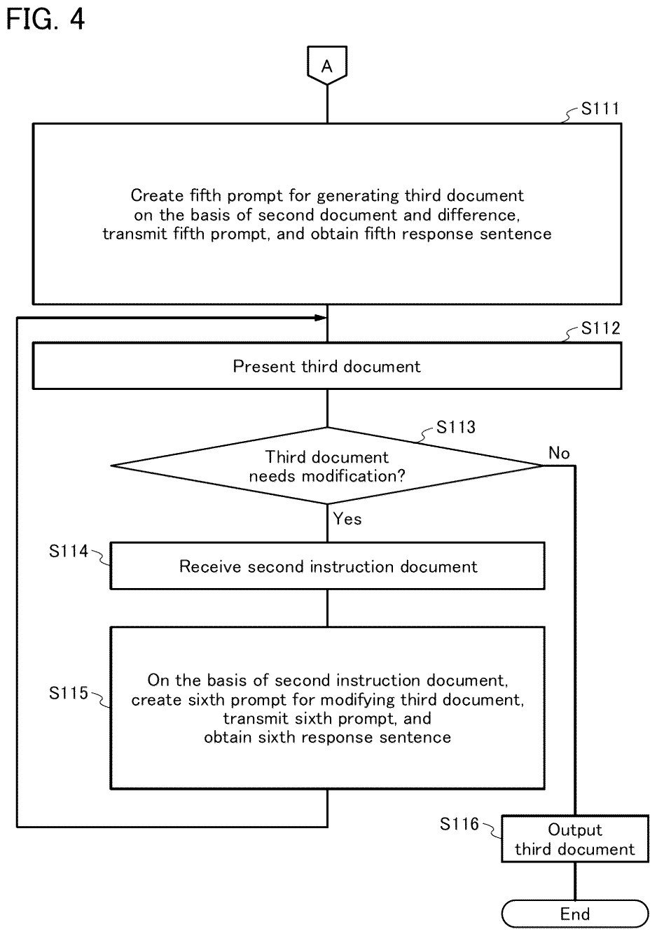

FIG. 3 and FIG. 4 are flow diagrams showing an example of the information processing method of one embodiment of the present invention, specifically, showing an example of the method for operating the information processing device 10.

When the information processing method of one embodiment of the present invention “starts”, the reception unit 110 receives the first and second documents in Step S101 in FIG. 3. As described above, the first document can be a document describing a creation to be filed, specifically, an invention, a device, or the like. As described above, the second document can be a prior art literature, e.g., a patent literature or a utility model literature. Examples of the patent literature include a published patent application and a patent publication. Examples of the utility model literature include a utility model publication. Note that the second document is not limited to a patent literature and a utility model literature. The second document may be a design document, a paper, a book, a journal, or the like. The second document is not limited to a published literature and may be an unpublished literature.

The second document can be one or more literatures. The second document can be, for example, at least part of literatures stored in a database. The second document can be a literature searched out from the database on the basis of the first document, for example.

In this specification, “search” refers to finding a document highly relevant to a search query document from a plurality of search target documents. In the above example, the search query document is the first document.

In the search, the first document and a literature may each be converted into vector data to obtain the degree of similarity between pieces of vector data. “Vector data” refers to multidimensional numerical data composed of integers of 0 to 9 with respect to text data composed of a character string (natural language) such as a text. The vector data can also be regarded as data in a format that can be subjected to arithmetic processing. Conversion of text data into vector data can be performed using AI, preferably using a neural network, for example. The neural network can be constructed with circuits (hardware) or programs (software). Specific examples of a method for converting text data into vector data include Bag of Words, distributed representations, and embedded representations. As an example of an indicator representing the degree of similarity between the pieces of vector data, cosine similarity is given. Note that Query Rewriting, ReRanking, agentization, or the like may be used for the search.

In this specification and the like, the neural network indicates a general model having the capability of solving problems, which is modeled on a biological neural network and determines the connection strength of neurons by learning. The neural network includes an input layer, an intermediate layer (hidden layer), and an output layer.

In the description of the neural network in this specification and the like, determining a connection strength of neurons (also referred to as weight coefficients) from the existing information is referred to as “learning” in some cases.

In this specification and the like, drawing a new conclusion from a neural network formed with the connection strength obtained by learning is referred to as “inference” in some cases.

The search may also be performed using a search formula. The “search formula” is a character string including at least a search word. The search formula may include a plurality of search words. The search formula may include a search condition, a classification code, or the like. Here, the search formula can include at least part of character strings included in the first document, for example. Examples of the search word include the field of the creation described in the first document.

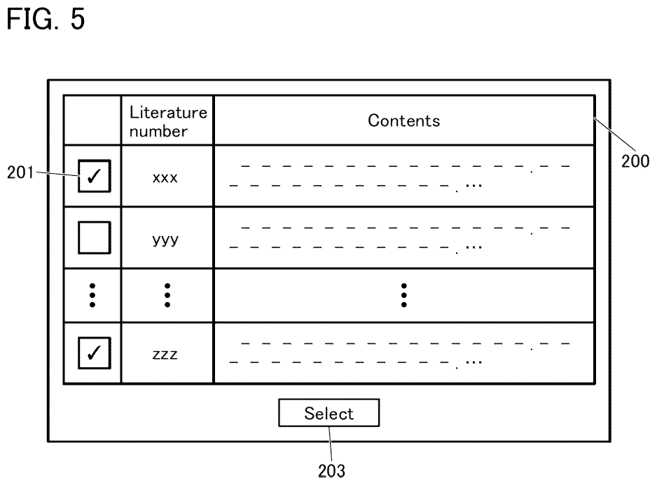

FIG. 5 shows an example of search results. In the example shown in FIG. 5, the search results are shown in a table 200. The table 200 can be displayed on the display portion of the information terminal 20. FIG. 5 can be regarded as an example of a graphical user interface (GUI) of the information processing system of one embodiment of the present invention. A form, an icon, a table, and the like in the GUI-related drawings such as FIG. 5 exemplified in this embodiment are examples, and there is no particular limitation. A GUI can be constructed as a web page accessed by the user of the information processing system via the network 30. Alternatively, a GUI can be constructed as a screen of a program application executed on the information terminal 20.

The table 200 includes a “Literature number” column and a “Contents” column. The “Literature number” column shows an identification number of a searched-out literature. In FIG. 5, “xxx”, “yyy”, and “zzz” denote literature numbers.

The “Contents” column shows at least part of the contents of a searched-out literature. Examples of the literature number include an application number, a publication number, and a registration number. As the literature numbers, numbers assigned to respective companies may be shown, for example. The contents can be one or both of a character string and a drawing included in the literature, for example. In the case of a patent literature or a utility model literature, its summary can be shown in the “Contents” column, for example.

Moreover, by selecting a literature number, for example, the contents of a literature may be displayed. By clicking a literature number, for example, the contents of the corresponding literature may be displayed. By clicking a literature number, for example, the specification, drawings, scope of claims, or the like of the corresponding literature may be displayed. Note that a literature number may be selected with use of a keyboard, for example. In the case where the information terminal 20 includes a touch panel, a literature number may be selected by touching the number. The following selection operations can also be performed in a similar manner. Furthermore, in the following GUIs that display information related to a literature such as a literature number, the contents of the literature can be displayed by selecting the displayed information.

In the table 200, a check box 201 is provided for each literature. A literature as the second document can be selected by placing a check mark in the check box 201 provided for the literature. FIG. 5 shows a button 203 marked with “Select”. When the button 203 is selected, the reception unit 110 can receive, as the second document, a literature whose check box 201 has a check mark therein, for example. Note that instead of the check box 201, a radio button or a text box may be displayed, for example.

In the example shown in FIG. 5, check marks are placed in the check boxes 201 of the literature number “xxx” and the literature number “zzz”, i.e., literatures with these literature numbers are selected. When the button 203 is selected in this state, the literature with the literature number “xxx” and the literature with the literature number “zzz” are supplied as the second documents from the database to the reception unit 110, for example. The button 203 can be selected by being clicked, for example. The button 203 may be selected with use of a keyboard. Furthermore, in the case where the information terminal 20 includes a touch panel, the button 203 may be selected by being touched. The following buttons can also be selected in a similar manner.

Here, the table 200 can include not only a literature searched out from the database on the basis of the first document but also a literature designated by the user of the information processing system, for example. The user can designate a literature to be included in the table 200 by specifying its literature number, for example. The table 200 can also include a literature searched out using a search formula designated by the user, for example.

Next, in Step S102 in FIG. 3, the processing unit 130 creates a first prompt and transmits it to the information processing device 40 through the output unit 140. Specifically, the first prompt is transmitted to a language model of the information processing device 40. The first prompt is a prompt for generating a summary sentence of the second document. The first prompt includes the second document. The first prompt also includes an order sentence such as “Summarize the following document.” Here, the language model to which the first prompt is transmitted is referred to as a text generation language model.

In this specification and the like, information included in a prompt is referred to as a context. A prompt includes an order sentence and a context. The context can be information related to the order sentence. In the first prompt, the second document can be a context.

The information processing device 40 generates a first response sentence on the basis of the first prompt with use of the text generation language model and supplies the first response sentence to the reception unit 110. In such a manner, the information processing device 10 obtains the first response sentence. The first response sentence includes the summary sentence of the second document. Here, in the case where the first prompt includes a plurality of the second documents, the text generation language model can generate summary sentences of respective second documents and supply them to the reception unit 110.

In the case where the second document is a patent literature or a utility model literature, a summary sentence is preferably generated using only a specification, for example. In other words, a summary sentence is preferably generated without using the scope of claims and the summary included in the patent literature or the utility model literature. In this case, the order sentence included in the first prompt can be “Summarize the specification included in the following literature”, for example. Note that the first prompt does not necessarily include the scope of claims, the summary, and the like included in the patent literature or the utility model literature. In the case where the second document is a design publication, the text generation language model can generate a summary sentence with use of one or both of the explanation of an object related to design and the explanation of design, for example.

Next, in Step S103 in FIG. 3, the processing unit 130 creates a second prompt and transmits it to the information processing device 40 through the output unit 140. Specifically, the second prompt is transmitted to a language model of the information processing device 40. The second prompt is a prompt for presenting a difference in the first document from the summary sentence of the second document. Specifically, as described above, the difference can be a feature, e.g., a technical feature that is not described in the summary sentence among features described in the first document. Here, the language model to which the second prompt is transmitted is referred to as a difference presentation language model. The difference presentation language model and the text generation language model can be different language models or the same language models.

The second prompt includes, as contexts, the first document and the summary sentence of the second document. That is, the second prompt includes the first document and the summary sentence of the literature selected on the GUI shown in FIG. 5, for example. Here, in the case where the second prompt includes a plurality of summary sentences of the second documents, i.e., the case where a plurality of literatures are selected on the GUI shown in FIG. 5, for example, the second prompt can be a prompt for presenting a feature described in none of the summary sentences as a difference. In this case, the second prompt includes an order sentence such as “Among features described in the input document, present a feature not described in any of summary sentences of literatures as a difference from the literature. Present the difference in bullet points.” Here, the input document represents the first document. Note that the second prompt may be a prompt for presenting differences in a plurality of summary sentences from the first document.

The information processing device 40 generates a second response sentence on the basis of the second prompt with use of the difference presentation language model and supplies the second response sentence to the reception unit 110. In such a manner, the information processing device 10 obtains the second response sentence. The second response sentence includes a difference in the first document from the summary sentence of the second document.

The difference presentation language model is a model having been subjected to fine-tuning, specifically, a model learned using a plurality of first data points and a plurality of second data points. The first data point includes a first order sentence, a first learning text, a second learning text, and a first learning response sentence. The second data point includes the first order sentence, a third learning text, a fourth learning text, and a second learning response sentence.

The first order sentence can be similar to the order sentence included in the above-described second prompt. The first and second data points can include the same order sentence.

The first and third learning texts each correspond to the above-described first document. The second and fourth learning texts each correspond to the summary sentence of the above-described second document.

The first learning response sentence is a response sentence showing a difference in the first learning text from the second learning text. The second learning response sentence is a response sentence showing the absence of a difference in the third learning text from the fourth learning text.

In the above-described fine-tuning, the difference presentation language model is learned so that the first learning response sentence can be output when a prompt including the first order sentence and the first and second learning texts is input. In addition, the difference presentation language model is learned so that the second learning response sentence can be output when a prompt including the first order sentence and the third and fourth learning texts is input. The fine-tuning can be performed by supervised learning using the first and second learning response sentences as labels.

As described above, compared with the case without fine-tuning, the case of performing fine-tuning on the difference presentation language model can effectively inhibit occurrence of hallucination. Performing fine-tuning using the second data point including the second learning response sentence can inhibit, in particular, the difference presentation language model from presenting a difference in the first document from the summary sentence of the second document even though there is no difference. Note that the number of first data points used for the learning of the difference presentation language model is preferably greater than or equal to the number of second data points, further preferably twice or more the number of second data points, still further preferably three times or more the number of second data points, for example. The difference presentation language model using a large number of first data points can easily present a difference in the first document from the summary sentence of the second document with high precision.

Next, in Step S104 in FIG. 3, the processing unit 130 presents, to the user of the information processing system, the above-described difference presented by the difference presentation language model. In such a manner, the processing unit 130 makes the user determine whether the difference is appropriate. The processing unit 130 creates data including the contents shown by the second response sentence and supplies the data to the information terminal 20 through the output unit 140, for example. Thus, the above-described difference is displayed on the display portion of the information terminal 20.

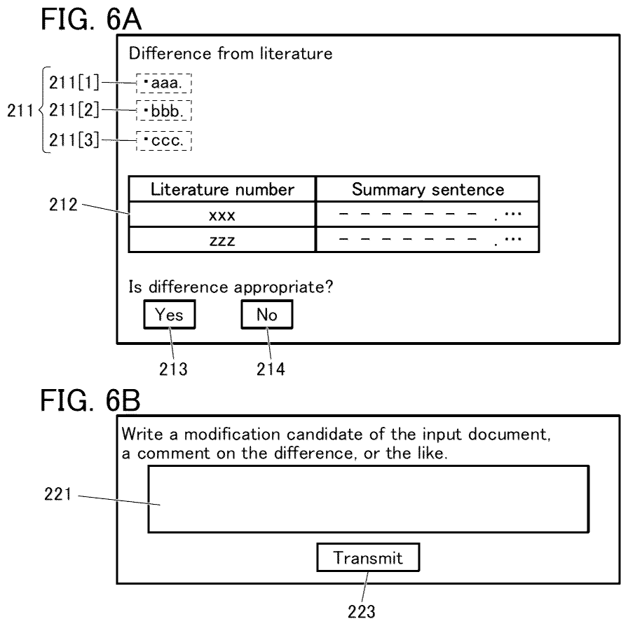

FIG. 6A shows an example of information displayed on the display portion of the information terminal 20 in Step S104. In other words, FIG. 6A shows an example of a GUI related to the information processing system of one embodiment of the present invention. Each of the following drawings showing an example of information displayed on the display portion can also be regarded as showing an example of the GUI related to the information processing system of one embodiment of the present invention.

In the example shown in FIG. 6A, a difference in the first document from the summary sentence of the second document is shown as “Difference from literature”. The difference shown as “Difference from literature” is referred to as a difference 211. In the example shown in FIG. 6A, “aaa.”, “bbb.”, and “ccc.” denote the difference 211. Here, “aaa.”, “bbb.”, and “ccc.” are referred to as a difference 211[1], a difference 211[2], and a difference 211[3], respectively. Note that not only a difference from the literature but also a commonality with the literature may be displayed. In this case, the second prompt is a prompt for presenting not only a difference between the first document and the summary sentence of the second document but also a commonality therebetween. Specifically, the order sentence in the second prompt includes a text for presenting the commonality.

In the example shown in FIG. 6A, a table 212 is shown. The table 212 includes a “Literature number” column and a “Summary sentence” column. The “Literature number” column shows an identification number of the second document, e.g., a literature number selected on the GUI shown in FIG. 5. In FIG. 6A, “xxx” and “zzz” denote literature numbers. The “Summary sentence” column shows the summary sentence generated in Step S102 in FIG. 3. Although not shown in FIG. 6A, the first document may be displayed on the display portion of the information terminal 20.

In the example shown in FIG. 6A, a question “Is difference appropriate?” is shown. In addition, a button 213 marked with “Yes” and a button 214 marked with “No” are shown. In the case where the user of the information processing system determines that the difference 211 is appropriate, the user selects the button 213. In the case where the user of the information processing system determines that the difference 211 is not appropriate, the user selects the button 214. When the button 213 is selected, data representing the determination that the difference 211 is appropriate is transmitted from the information terminal 20 to the reception unit 110. In this case, the process proceeds to Step S108 from the branching point of Step S105 in FIG. 3. When the button 214 is selected, data representing the determination that the difference 211 is not appropriate is transmitted from the information terminal 20 to the reception unit 110. In this case, the process proceeds to Step S106 from the branching point of Step S105 in FIG. 3. Thus, Step S105 can be regarded as a step in which the reception unit 110 receives the determination whether the difference 211 is appropriate, specifically, the data representing the determination.

In Step S106, the reception unit 110 receives the first instruction document. FIG. 6B shows an example of information displayed on the display portion of the information terminal 20 when the button 214 shown in FIG. 6A is selected.

In the example shown in FIG. 6B, a form 221 is shown below a sentence “Write a modification candidate of the input document, a comment on the difference, or the like.” Here, the input document refers to the first document. In addition, a button 223 marked with “Transmit” is shown below the form 221.

The user of the information processing system inputs, for example, a text in the form 221. After that, by selecting the button 223, the contents described in the form 221 are supplied as the first instruction document from the information terminal 20 to the reception unit 110.

As described above, the first instruction document can include at least one of an instruction to modify the first document and a comment on the difference 211, for example. Here, the comment on the difference 211 can be an opinion on the difference 211, for example. In the case where the user of the information processing system considers that there is another difference in the first document from the second document in addition to the difference 211, for example, the first instruction document can include a text showing this idea. Moreover, in the case where the user of the information processing system considers that the second document contains at least part of the difference 211, the first instruction document can include a text showing this idea.

The user of the information processing system can input, in the form 221, a sentence such as “Modify the input document as follows”, “ddd is probably disclosed in none of the literatures”, or “aaa is probably disclosed in the paragraph [a₁b₁c₁d₁] (a₁, b₁, c₁, and d₁ are each an integer greater than or equal to 0 and less than or equal to 9) of the literature with the literature number xxx.” In addition, the user of the information processing system may input sentences in bullet points in the form 221. Note that in the case where the difference presentation language model determines that the difference 211 is absent in Step S103 in FIG. 3, the processing unit 130 can make the display portion of the information terminal 20 display a text showing the absence of the difference, the table 212, the form 221, and the button 223, for example.

Note that the form 221 and the button 223 may be displayed on the GUI shown in FIG. 6A. Here, the buttons 213 and 214 are not necessarily displayed. In this case, when the button 223 is selected while the form 221 is blank, for example, the process can proceed to Step S108 from the branching point of Step S105 in FIG. 3. Moreover, when the button 223 is selected while characters are input in the form 221, the process can proceed to Step S106 from the branching point of the Step S105 in FIG. 3. Note that the process may proceed to Step S108 not only when the button 223 is selected while the form 221 is blank but also when the button 223 is selected while only a predetermined character is input in the form 221. For example, the process may proceed to Step S108 when the button 223 is selected while only a blank character, a symbol, or a special character is input in the form 221.

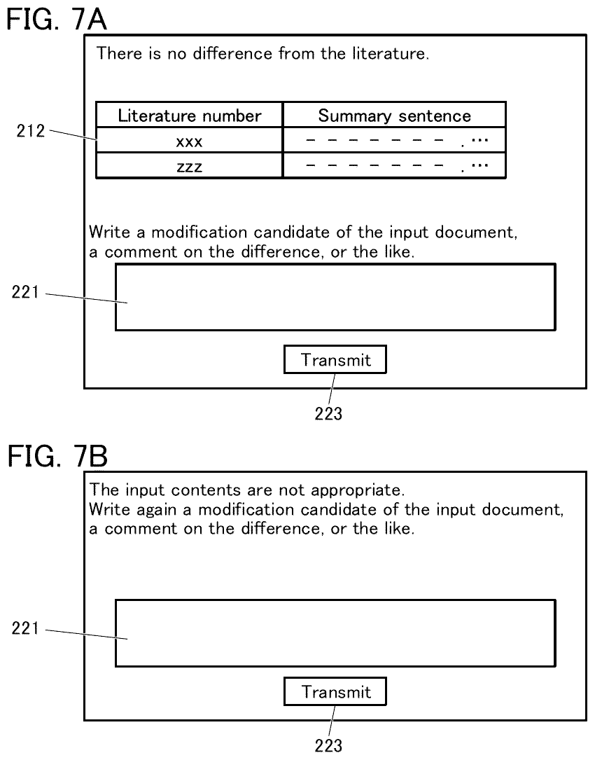

FIG. 7A shows an example of information displayed on the display portion of the information terminal 20 in the case where a difference in the first document from the summary sentence of the second document is not presented in Step S103. In the example shown in FIG. 7A, a sentence “There is no difference from the literature.” is displayed. In the example shown in FIG. 7A, the form 221 and the button 223 that are shown in FIG. 6B are shown. An instruction to modify the first document can be entered in the form 221 shown in FIG. 7A, for example.

By performing fine-tuning on the difference presentation language model using the above-described first and second data points, in the case where the first document has no difference from the summary sentence of the second document, the sentence showing the absence of the difference can be displayed as shown in FIG. 7A. This can inhibit a phenomenon where the difference 211 shown in FIG. 6A is displayed although the first document has no difference from the summary sentence of the second document. That is, occurrence of hallucination can be inhibited. Accordingly, even a person inexperienced in the intellectual property business can prepare a highly complete specification, for example.

In Step S107 after Step S106 in FIG. 3, the processing unit 130 creates a third prompt on the basis of the first instruction document and transmits the third prompt to the information processing device 40 through the output unit 140. Specifically, the third prompt is transmitted to the difference presentation language model of the information processing device 40. The third prompt is a prompt for presenting a difference in the first document from the summary sentence of the second document on the basis of the contents of the first instruction document.

The third prompt includes, as contexts, the first instruction document as well as the first document and the summary sentence of the second document. The third prompt includes an order sentence such as “On the basis of the following contents, modify the input document and answer the question. Among features described in the input document, present a feature not described in any of summary sentences of literatures as a difference from the literature. Present the difference in bullet points.”

The processing unit 130 may transmit the third prompt to both the text generation language model and the difference presentation language model. In this case, an order sentence in the third prompt to be transmitted to the text generation language model is, for example, “On the basis of the following contents, modify the input document and answer the question.” In addition, an order sentence in the third prompt to be transmitted to the difference presentation language model is, for example, “On the basis of the following contents, among features described in the input document, present a feature not described in any of summary sentences of literatures as a difference. Present the difference in bullet points.” The first document, the summary sentence of the second document, and the first instruction document can be included in both the third prompt to be transmitted to the text generation language model and the third prompt to be transmitted to the difference presentation language model. Note that in the case where the third prompt is transmitted to both the text generation language model and the difference presentation language model, the processing unit 130 may transmit the third prompt to the text generation language model to obtain a response sentence, and then transmit the third prompt including the response sentence to the difference presentation language model.

The information processing device 40 generates a third response sentence on the basis of the third prompt with use of the difference presentation language model and supplies the third response sentence to the reception unit 110. In such a manner, the information processing device 10 obtains the third response sentence. Like the second response sentence, the third response sentence includes a difference in the first document from the summary sentence of the second document. Here, the difference can be based on the first instruction document. In addition, the third response sentence can include an answer to the comment included in the first instruction document.

The difference presentation language model can be subjected to fine-tuning using a plurality of third data points and a plurality of fourth data points as well as the above-described first and second data points. The third data point includes a second order sentence, a fifth learning text, a sixth learning text, a first learning instruction document, and a third learning response sentence. The fourth data point includes the second order sentence, a seventh learning text, an eighth learning text, a second learning instruction document, and a fourth learning response sentence.

The second order sentence can be similar to the order sentence included in the above-described third prompt. The third and fourth data points can include the same order sentence.

The fifth and seventh learning texts each correspond to the above-described first document. The sixth and eighth learning texts each correspond to the summary sentence of the above-described second document. The first and second learning instruction documents each correspond to the above-described first instruction document.

The third learning response sentence is a response sentence showing a difference in the fifth learning text from the sixth learning text. The difference presented by the third learning response sentence is based on the first learning instruction document. The fourth learning response sentence is a response sentence showing that the second learning instruction document is not appropriate as a material for determining a difference in the seventh learning text from the eighth learning text.

In the above-described fine-tuning, the difference presentation language model is learned so that the third learning response sentence can be output when a prompt including the second order sentence, the fifth and sixth learning texts, and the first learning instruction document is input. In addition, the difference presentation language model is learned so that the fourth learning response sentence can be output when a prompt including the second order sentence, the seventh and eighth learning texts, and the second learning instruction document is input. The fine-tuning can be performed by supervised learning using the third and fourth learning response sentences as labels.

FIG. 7B shows an example of information displayed on the display portion of the information terminal 20 in the case where the difference presentation language model determines in Step S107 that the contents of the first instruction document are not appropriate as a material for determining a difference in the first document from the summary sentence of the second document. In the example shown in FIG. 7B, sentences “The input contents are not appropriate. Write again a modification candidate of the input document, a comment on the difference, or the like.” are displayed. In the example shown in FIG. 7B, the form 221 and the button 223 that are shown in FIG. 6B and the like are shown.

As described above, by performing fine-tuning on the difference presentation language model using the third and fourth data points, the user of the information processing system can be prompted to re-input the first instruction document in the case where the contents of the first instruction document are not appropriate. Accordingly, the user of the information processing system of one embodiment of the present invention can easily prepare a highly complete specification. Note that the number of third data points used for the learning of the difference presentation language model is preferably greater than or equal to the number of fourth data points, further preferably twice or more the number of fourth data points, still further preferably three times or more the number of fourth data points, for example. The difference presentation language model using a large number of third data points can easily present a difference in the first document from the summary sentence of the second document with high precision.

After Step S107 in FIG. 3, Steps S104 and S105 are performed again. Here, the display portion of the information terminal 20 can display, for example, an answer to the comment included in the first instruction document as well as the difference 211, the table 212, and the buttons 213 and 214 that are shown in FIG. 6A. In the case where the first document is modified on the basis of the first instruction document, the modified first document can be displayed on the display portion of the information terminal 20.

In Step S108 in FIG. 3, the processing unit 130 creates a fourth prompt and transmits it to the information processing device 40 through the output unit 140. Specifically, the fourth prompt is transmitted to the difference presentation language model of the information processing device 40. The fourth prompt is a prompt for confirming the absence of the difference 211 shown in FIG. 6A in the second document. That is, the fourth prompt is a prompt for detecting the difference 211 described not in the summary sentence of the second document but in the second document itself.

The fourth prompt includes, as contexts, the difference 211 and the second document. The fourth prompt also includes order sentences such as “Confirm that a difference between the literature and the first document is disclosed in none of the literatures. If a difference is disclosed, present the difference.”

The information processing device 40 generates a fourth response sentence on the basis of the fourth prompt with use of the difference presentation language model and supplies the fourth response sentence to the reception unit 110. In such a manner, the information processing device 10 obtains the fourth response sentence. The fourth response sentence includes a confirmation result. The fourth response sentence also includes whether the description of the difference 211 is included in the second document.

Next, in Step S109 in FIG. 3, the processing unit 130 presents the above-described confirmation result to the user of the information processing system. The processing unit 130 creates data including the contents shown by the fourth response sentence and supplies the data to the information terminal 20 through the output unit 140, for example. Thus, the above-described confirmation result is displayed on the display portion of the information terminal 20.

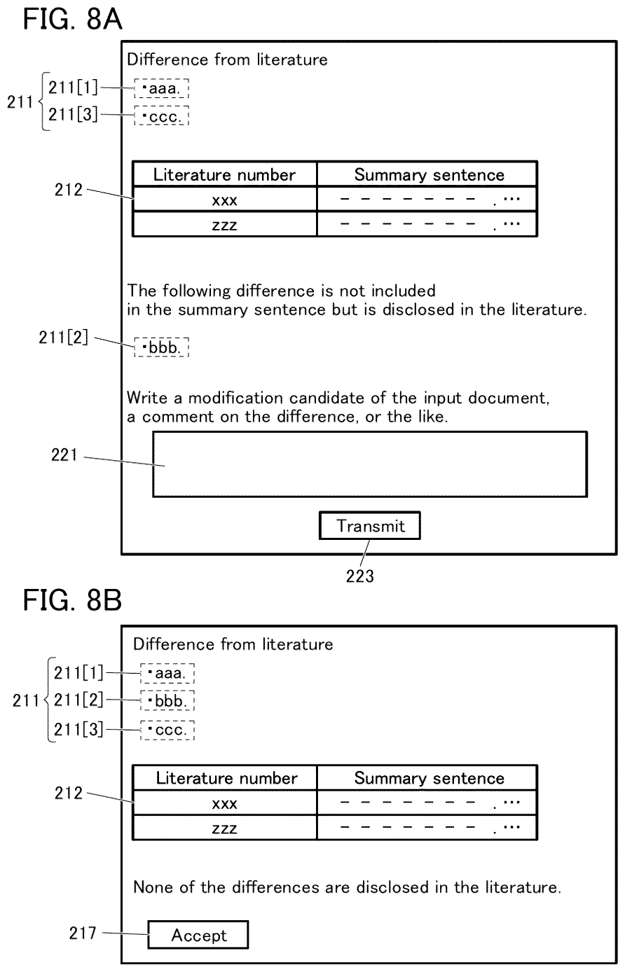

FIG. 8A shows an example of information displayed on the display portion of the information terminal 20 in the case where the difference 211[2] is determined to be contained in the second document. In the example shown in FIG. 8A, the differences 211[1] and 211[3] are shown as differences from the literature. Meanwhile, unlike in the example shown in FIG. 6A, the difference 211[2] is not shown. Furthermore, a sentence “The following difference is not included in the summary sentence but is disclosed in the literature.” is shown as the confirmation result, and the difference 211[2] is shown as such a difference. In addition, the form 221 and the button 223 that are shown in FIG. 6B are shown. Note that although not shown in the example shown in FIG. 8A, the literature number of the literature containing the difference 211[2] may be shown.

FIG. 8B shows an example of information displayed on the display portion of the information terminal 20 in the case where it is determined that none of the differences 211[1], 211[2], and 211[3] shown in FIG. 6A are contained in the second document. In the example shown in FIG. 8A, a sentence “None of the differences are disclosed in the literature.” is shown as the confirmation result as well as the difference 211 and the table 212 that are shown in FIG. 6A. Furthermore, in the example shown in FIG. 8B, a button 217 marked with “Accept” is shown.

In the case where the second document is determined to contain at least part of the difference 211, i.e., the case where the confirmation result shown in FIG. 8A is displayed on the display portion of the information terminal 20, for example, the process proceeds to Step S106 from the branching point of Step S110 in FIG. 3. Here, the first instruction document can include a comment on the confirmation result shown in FIG. 8A, for example. The comment on the confirmation result can be an opinion on the confirmation result, for example. In the case where the user of the information processing system considers that the difference 211[2] is not contained in the second document, for example, the first instruction document can include a text showing this idea.

In the case where the difference 211 is determined to be absent in the second document, i.e., the case where the confirmation result shown in FIG. 8B is displayed on the display portion of the information terminal 20, the process proceeds to Connector A from the branching point of Step S110 in FIG. 3. Specifically, when the user of the information processing system selects the button 217, the process proceeds to Connector A. Note that although not shown in FIG. 8B, a button for performing the processing in Step S106 may be provided. For example, by selecting the button, the form 221 and the button 223 may be displayed on the display portion of the information terminal 20.

In the process shown in FIG. 3, Steps S102 and S108 to S110 are not necessarily performed. In this case, the processing unit 130 creates, as a second prompt, a prompt for presenting a difference in the first document from the second document itself in Step S103. In the case where the user of the information processing system determines that the difference 211 is appropriate, the process proceeds to Connector A from the branching point of Step S105.

By performing Steps S102 and S108 to S110, the difference 211 is easily presented by the processing unit 130. For example, a technical feature described in the first document is easily compared with that described in the second document and thus the difference 211 based on the comparison results is easily presented. In contrast, by not performing Steps S102 and S108 to S110, the number of processing steps performed by the information processing system can be reduced.

Connector A is connected to Step S111 shown in FIG. 4. In Step S111, the processing unit 130 creates a fifth prompt and transmits it to the information processing device 40 through the output unit 140. Specifically, the fifth prompt is transmitted to the text generation language model of the information processing device 40. The fifth prompt is a prompt for generating the third document on the basis of the second document and the difference 211.

The fifth prompt includes, as contexts, the second document and the difference 211. The fifth prompt also includes an order sentence such as “Generate a document on the basis of the literature and the difference.” Note that the fifth prompt may include the first document. This can sometimes inhibit a phenomenon where a structure shown in the first document is not shown in the third document. Meanwhile, in the case where the fifth prompt does not include the first document, for example, a phenomenon where the third document is generated in a format different from that of the second document can sometimes be inhibited.

The information processing device 40 generates a fifth response sentence on the basis of the fifth prompt with use of the text generation language model and supplies the fifth response sentence to the reception unit 110. In such a manner, the information processing device 10 obtains the fifth response sentence. The fifth response sentence includes the third document.

The third document is generated on the basis of the second document and thus can be a document of the same kind as the second document. For example, in the case where the second document is a patent application document or a utility model application document, the third document can also be a patent application document or a utility model application document. Specifically, in the case where the second document is a specification, the third document can also be a specification.

Next, in Step S112 in FIG. 4, the processing unit 130 presents, to the user of the information processing system, the third document generated by the text generation language model. In such a manner, the processing unit 130 makes the user check the third document. The processing unit 130 creates data including the contents shown by the fifth response sentence and supplies the data to the information terminal 20 through the output unit 140, for example. Thus, the third document is displayed on the display portion of the information terminal 20.

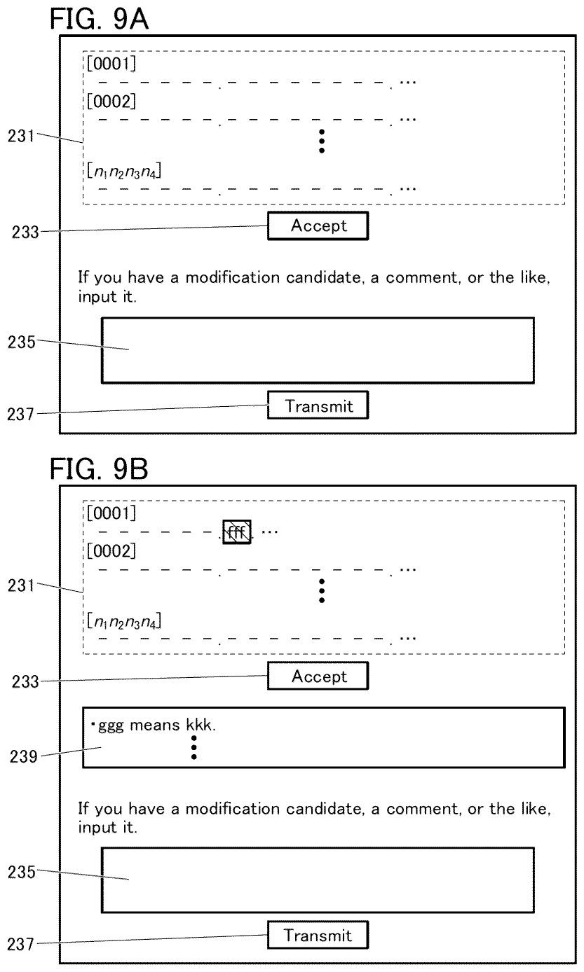

FIG. 9A shows an example of information displayed on the display portion of the information terminal 20 in Step S112 after Step S111. In FIG. 9A, the third document generated by the text generation language model is referred to as a document 231. Also in the following drawings, the third document is referred to as the document 231 in some cases. The document 231 is also referred to as a generated document.

In the example shown in FIG. 9A, the document 231, a button 233 marked with “Accept”, a form 235, and a button 237 marked with “Transmit” are shown. In the example shown in FIG. 9A, the form 235 and the button 237 are displayed below a sentence “If you have a modification candidate, a comment, or the like, input it.”

For example, in the case where the second document is a specification, the document 231 can be a document in the format of a specification. In the example shown in FIG. 9A, a paragraph number is added to each paragraph in the document 231. In the example shown in FIG. 9A, [0001], [0002], and [n₁n₂n₃n₄] (n₁, n₂, n₃, and n₄ are each an integer greater than or equal to 0 and less than or equal to 9) denote paragraph numbers. Note that a paragraph including the difference 211 may be emphasized, for example. Examples of emphasis methods include changing the background color, changing the text color, increasing the font size, changing the font, bolding, and underlining.

In the case where the user of the information processing system determines that the document 231 is completed and does not need modification, for example, the user selects the button 233. In the case where the user of the information processing system determines that the document 231 needs modification, for example, the user inputs an instruction related to modification in the form 235, and then selects the button 237. When the button 233 is selected, data representing the determination that the document 231 does not need modification is transmitted from the information terminal 20 to the reception unit 110. In this case, the process proceeds to Step S116 from the branching point of Step S113 in FIG. 4. When the button 237 is selected, data representing the determination that the document 231 needs modification is transmitted from the information terminal 20 to the reception unit 110. In this case, the process proceeds to Step S114 from the branching point of Step S113 in FIG. 4. Thus, Step S113 can be regarded as a step in which the reception unit 110 receives the determination whether the document 231 needs modification, specifically, the data representing the determination.

Examples of the instruction related to modification include “Add the description of the structure ddd between the paragraphs [p₁p₂p₃1] and [p₁p₂p₃2] (p₁, p₂, and p₃ are each an integer greater than or equal to 0 and less than or equal to 9)”, “Modify the structure eee described in the paragraph [p₄p₅q₁q₂] (p₄, p₅, q₁, and q₂ are each an integer greater than or equal to 0 and less than or equal to 9) into the structure fff”, “Explain the structure fff and then explain the structure ddd”, “Add the more detailed explanation of the term eee on the basis of the literature xxx”, “Add the effect of the structure fff”, and “Delete the paragraph [q₃p₆q₄p₇] (p₆, p₇, q₃, and q₄ are each an integer greater than or equal to 0 and less than or equal to 9).” In addition, the user of the information processing system may input instructions in bullet points in the form 235.

The user of the information processing system can input, in the form 235, information necessary for modifying the document 231. For example, a document not used as the second document can be input in the form 235. Specifically, a literature, such as a patent application document or a paper, that is not selected as the second document can be input in the form 235. In addition, the address of a related web page, a text explaining a term definition, or the like can be input in the form 235.

In the form 235, a comment on the document 231 may also be input. The comment can be a question about the document 231, for example. In this case, an instruction related to modification is not necessarily input in the form 235. That is, even in the case where the user of the information processing system determines that the document 231 does not need modification, if the user has a comment on the document 231, the process can proceed to Step S114 from the branching point of Step S113 in FIG. 4. Examples of the question about the document 231 include “What does ggg mean in the paragraph [r₁r₂r₃r₄] (r₁, r₂, r₃, and r₄ are each an integer greater than or equal to 0 and less than or equal to 9)?” and “What effect is produced by the structure in the paragraph [s₁s₂s₃s₄] (s₁, s₂, s₃, and s₄ are each an integer greater than or equal to 0 and less than or equal to 9)?” Note that in the case where the user of the information processing system does not want to modify the document 231, the user may write “Do not modify the document.” in the form 235, for example.

Note that the button 233 is not necessarily displayed on the GUI shown in FIG. 9A. In this case, when the button 237 is selected while the form 235 is blank, for example, the process can proceed to Step S116 from the branching point of Step S113 in FIG. 4. Note that the process may proceed to Step S116 when the button 237 is selected while only a predetermined character is input in the form 235, as well as when the button 223 is selected while only a predetermined character is input in the form 221.

In Step S114 in FIG. 4, the reception unit 110 receives the second instruction document. Specifically, the text input in the form 235 can be the second instruction document.

In Step S115 after Step S114 in FIG. 4, the processing unit 130 creates a sixth prompt on the basis of the second instruction document and transmits the sixth prompt to the information processing device 40 through the output unit 140. Specifically, the sixth prompt is transmitted to the text generation language model of the information processing device 40. The sixth prompt is a prompt for modifying the third document on the basis of the second instruction document.

The sixth prompt includes, as contexts, the third document and the second instruction document. The sixth prompt also includes order sentences such as “Answer the following contents and modify the generated document. Present the answer in bullet points.” Note that like the fifth prompt, the sixth prompt can include the second document and the difference 211. The sixth prompt may also include the first document. The sixth prompt can include the first document in the case where the fifth prompt includes the first document, for example.

The information processing device 40 generates a sixth response sentence on the basis of the sixth prompt with use of the text generation language model and supplies the sixth response sentence to the reception unit 110. In such a manner, the information processing device 10 obtains the sixth response sentence. The sixth response sentence can include the modified third document, for example. In addition, the sixth response sentence can include an answer to a comment included in the second instruction document.

After Step S115 in FIG. 4, Step S112 is performed again. FIG. 9B shows an example of information displayed on the display portion of the information terminal 20 in Step S112 after Step S115. Differences from FIG. 9A will be mainly described below.

In the example shown in FIG. 9B, a modified portion in the document 231 is hatched. Specifically, in the example shown in FIG. 9B, “fff” is added and hatched. It is preferable to emphasize the modified portion in the document 231 in such a manner because the user of the information processing system can easily recognize the modified portion. As described above, examples of emphasis methods include changing the background color, changing the text color, increasing the font size, changing the font, bolding, and underlining. Emphasis may be performed on each sentence or each paragraph. That is, even when modification is performed just partly, an entire text or an entire paragraph may be emphasized.

In the example shown in FIG. 9B, an answer to the comment included in the second instruction document is shown in a region 239. FIG. 9B shows “ggg means kkk.” as an example of the answer to the comment. For example, in the case where the second instruction document includes a comment “What does ggg mean?”, the answer shown in FIG. 9B can be displayed in the region 239. Note that the region 239 may display one or both of a modified portion and a modification content of the document 231. Alternatively, a region different from the region 239 may display one or both of a modified portion and a modification content of the document 231.

In Step S116 in FIG. 4, the processing unit 130 outputs the third document. The processing unit 130 supplies the third document to the database through the output unit 140, for example. The processing unit 130 can supply the third document to the information terminal 20 through the output unit 140, for example. The third document supplied to the information terminal 20 can be displayed on the display portion, for example. The third document supplied to the information terminal 20 can be stored in the information terminal 20, for example. Accordingly, the information processing method of one embodiment of the present invention “ends”.

In the above-described manner, with use of the information processing system of one embodiment of the present invention, the third document can be generated on the basis of the difference in the first document from the second document. A specification related to the creation described in the first document can be prepared so that a technical feature not disclosed in a prior art literature is emphasized in the specification, for example. As described above, the information processing system of one embodiment of the present invention can assist preparation of a document related to an intellectual property, e.g., a specification. Thus, with use of the information processing system of one embodiment of the present invention, even a person inexperienced in the intellectual property business can prepare a document related to an intellectual property, e.g., a specification in a short time. In addition, it is possible to reduce the workload on a user in preparing a document related to an intellectual property, e.g., a specification.

Moreover, in the information processing system of one embodiment of the present invention, owing to the first instruction document created by the user, the difference presentation language model can present a difference in the first document from the second document a plurality of times. Specifically, the difference presentation language model can present the difference a plurality of times on the basis of the contents of the first instruction document. Furthermore, in the information processing system of one embodiment of the present invention, owing to the second instruction document created by the user, the text generation language model can modify the third document at least once. Thus, the user of the information processing system of one embodiment of the present invention can prepare the third document in an interactive manner. Accordingly, even a person inexperienced in the intellectual property business can prepare a highly complete specification, for example.

As described above, one embodiment of the present invention can provide an information processing device, an information processing method, and an information processing system that are highly convenient and useful.

### <Information Processing Method 2>

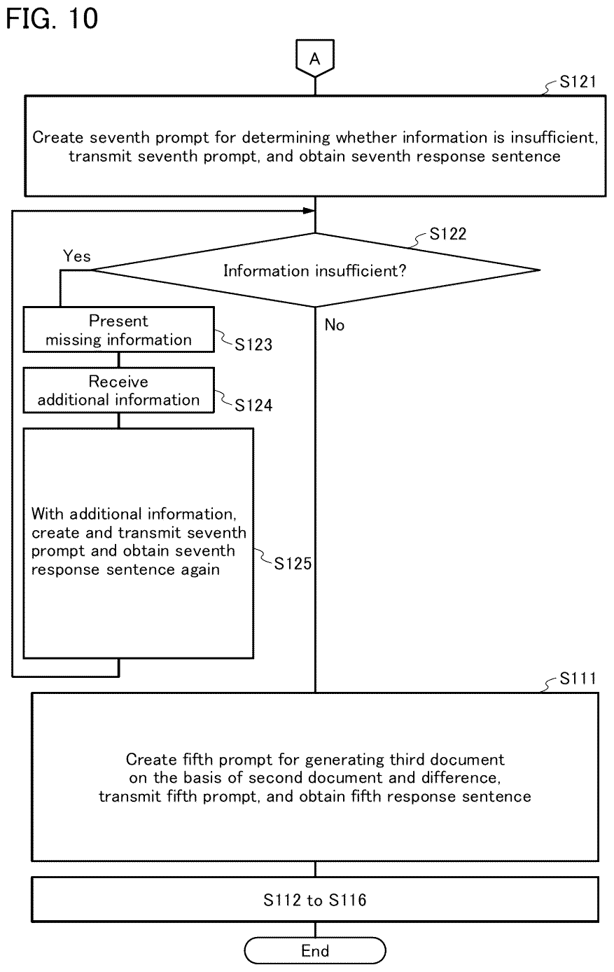

FIG. 10 is a flow diagram showing an example of the processing after Connector A, which is different from that in FIG. 4. In the example shown in FIG. 10, Steps S121, S122, S123, S124, and S125 are shown before Step S111.

In Step S121, the processing unit 130 creates a seventh prompt and transmits it to the information processing device 40 through the output unit 140. Specifically, the seventh prompt is transmitted to a language model of the information processing device 40. The seventh prompt is a prompt for determining whether information for generating the third document is insufficient. Moreover, the seventh prompt is a prompt for, when the information is insufficient, presenting the kind of missing information. Here, the language model to which the seventh prompt is transmitted is referred to as a missing information presentation language model. The missing information presentation language model and the difference presentation language model can be different language models or the same language models. The text generation language model, the difference presentation language model, and the missing information presentation language model can be different language models or the same language models.

The seventh prompt includes, as contexts, the second document and the difference 211. The seventh prompt also includes order sentences such as “Determine whether information for generating a document satisfying an enablement requirement on the basis of the literature and the difference is insufficient. If the information is insufficient, present the kind of missing information.” Note that the seventh prompt may include the first document. For example, in the case where the processing unit 130 creates the fifth prompt including the first document in later Step S111, the seventh prompt preferably also includes the first document.

The information processing device 40 generates a seventh response sentence on the basis of the seventh prompt with use of the missing information presentation language model and supplies the seventh response sentence to the reception unit 110. In such a manner, the information processing device 10 obtains the seventh response sentence. The seventh response sentence includes a determination result of whether the information for generating the third document is insufficient. When the information is insufficient, the seventh prompt includes the kind of missing information.

For example, in the case where the third document includes an example and the first document does not sufficiently describe experimental conditions, experimental conditions can be regarded as missing information. In the case where the first document describes a structure of a transistor and the second document describes a structure and a manufacturing method of a transistor but the first document does not describe a manufacturing method of a transistor, a manufacturing method of a transistor can be regarded as missing information. For another example, in the case where the first document describes the physical property, e.g., electrical resistivity of a material but does not describe a specific material name, a material name can be regarded as missing information. Note that it can be determined that a matter not described in either the second document or the difference 211 is not described also in the first document.

The missing information presentation language model can be a model having been subjected to fine-tuning. The fine-tuning can be performed using a plurality of fifth data points and a plurality of sixth data points. The fifth data point includes a third order sentence, a ninth learning text, a tenth learning text, and a fifth learning response sentence. The sixth data point includes the third order sentence, an eleventh learning text, a twelfth learning text, and a sixth learning response sentence.

The third order sentence can be similar to the order sentence included in the above-described seventh prompt. The fifth and sixth data points can include the same order sentence.

The ninth and eleventh learning texts each correspond to the above-described second document. The tenth and twelfth learning texts each correspond to the difference 211.

The fifth learning response sentence is a response sentence presenting missing information for generating a document on the basis of the ninth and tenth learning texts. The sixth learning response sentence is a response sentence showing that information for generating a document on the basis of the eleventh and twelfth learning texts is not insufficient. These documents each correspond to the above-described third document.

In the above-described fine-tuning, the missing information presentation language model is learned so that the fifth learning response sentence can be output when a prompt including the third order sentence and the ninth and tenth learning texts is input. In addition, the missing information presentation language model is learned so that the sixth learning response sentence can be output when a prompt including the third order sentence and the eleventh and twelfth learning texts is input. The fine-tuning can be performed by supervised learning using the fifth and sixth learning response sentences as labels.

As described above, compared with the case without fine-tuning, the case of performing fine-tuning on the missing information presentation language model can effectively inhibit occurrence of hallucination. Performing fine-tuning using the sixth data point including the sixth learning response sentence can inhibit, in particular, the missing information presentation language model from presenting missing information even though the information for generating the third document is not insufficient. Note that the number of fifth data points used for the learning of the missing information presentation language model is preferably greater than or equal to the number of sixth data points, further preferably twice or more the number of sixth data points, still further preferably three times or more the number of sixth data points, for example. The missing information presentation language model using a large number of fifth data points can easily present the kind of information for generating the third document with high precision.

In the case where the information for generating the third document is insufficient, the process proceeds to Step S123 from the branching point of Step S122. In the case where the information for generating the third document is not insufficient, the process proceeds to Step S111 from the branching point of Step S122.

In Step S123, the processing unit 130 presents missing information for generating the third document to the user of the information processing system. The processing unit 130 creates data including the contents shown by the seventh response sentence and supplies the data to the information terminal 20 through the output unit 140, for example. Thus, the missing information for generating the third document is displayed on the display portion of the information terminal 20.

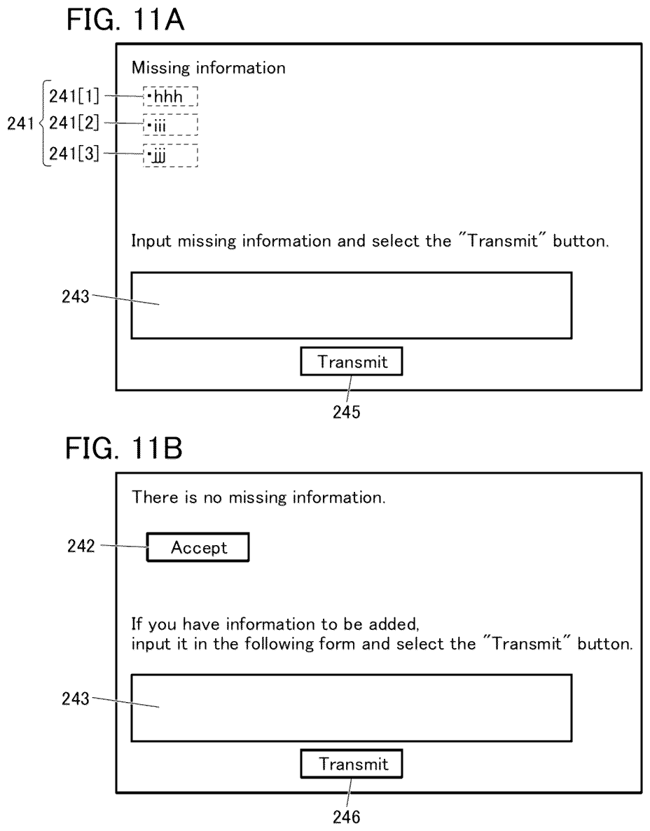

FIG. 11A shows an example of information displayed on the display portion of the information terminal 20 in Step S123. In the example shown in FIG. 11A, missing information for generating the third document is shown as “Missing information”. The information shown as “Missing information” is referred to as information 241. In the example shown in FIG. 11A, “hhh”, “iii”, and “jjj” denote the information 241. Here, “hhh”, “iii”, and “jjj” are information 241[1], information 241[2], and information 241[3], respectively.

In the example shown in FIG. 11A, a form 243 is shown below a sentence “Input missing information and select the “Transmit” button.” In addition, a button 245 marked with “Transmit” is shown below the form 243.

On the basis of the information 241, the user of the information processing system inputs missing information for generating the third document in the form 243. After that, by selecting the button 245, the contents described in the form 243 are supplied as additional information from the information terminal 20 to the reception unit 110.

For example, in the case where the information 241[1] is an experimental condition, the user of the information processing system inputs the experimental condition in the form 243. For example, in the case where the information 241[2] is a manufacturing method of a transistor, the user of the information processing system inputs the manufacturing method of a transistor in the form 243. For example, in the case where the information 241[3] is a conductive material having an electrical resistivity lower than or equal to x Ω·cm, the user of the information processing system inputs the specific name of the conductive material in the form 243. In such a manner, the user of the information processing system can input additional information corresponding to the information 241 in the form 243. Note that the information processing system may be configured so that not only a character string but also a drawing can be input in the form 243, for example. Moreover, the information processing system may be configured so that additional information can be input for each information 241 in a table format in the form 243.

In Step S124 in FIG. 10, the reception unit 110 receives the above-described additional information. Specifically, information in a text and the like input in the form 243 can be the additional information.

In Step S125, the processing unit 130 creates again the seventh prompt so that the additional information is included therein and transmits the seventh prompt to the information processing device 40 through the output unit 140. In the case where the information for generating the third document is still insufficient after Step S125, the process proceeds to Step S123 again from the branching point of Step S122. In the case where the information for generating the third document becomes sufficient, the process proceeds to Step S111 from the branching point of Step S122. In Step S111, the processing unit 130 creates the fifth prompt so that the additional information is included therein. In this case, the fifth prompt includes the additional information as well as the second document and the difference 211. The fifth prompt can include an order sentence such as “Generate a document on the basis of the literature, the difference, and the additional information.”

As described above, in the information processing method shown in FIG. 10 and FIG. 11A, missing information can be added before the text generation language model generates the third document. Thus, the highly complete third document can be prepared.

In the case where the information for generating the third document is determined not to be insufficient in Step S121, this idea may be presented to the user of the information processing system. After the user of the information processing system confirms that the information for generating the third document is not insufficient, the processing unit 130 may perform the processing in Step S111. FIG. 11B shows an example of information displayed on the display portion of the information terminal 20 in the case where the information for generating the third document is determined not to be insufficient in Step S121. In the example shown in FIG. 11B, a sentence “There is no missing information.” is shown as a determination result. Furthermore, in the example shown in FIG. 11B, a button 242 marked with “Accept” is shown. When the user of the information processing system selects the button 242, the processing unit 130 can perform the processing in Step S111.

In the example shown in FIG. 11B, the form 243 and a button 246 marked with “Transmit” are shown below a sentence “If you have information to be added, input it in the following form and select the “Transmit” button.” In this case, the user of the information processing system can input additional information in the form 243 even when the information for generating the third document is determined not to be insufficient in Step S121. When the user of the information processing system selects the button 246, the processing unit 130 can perform Step S124 and then perform Step S111. Note that after the button 246 is selected, the processing unit 130 may perform Step S125 instead of Step S111. The GUI shown in FIG. 11B does not necessarily display the form 243 and the button 246.

Performing fine-tuning on the missing information presentation language model using the fifth and sixth data points can inhibit a phenomenon where not the contents shown in FIG. 11B but the information 241 in FIG. 11A is displayed even though the information for generating the third document is not insufficient. That is, occurrence of hallucination can be inhibited.

Accordingly, an information processing device, an information processing method, and an information processing system that are highly convenient and useful can be provided.

### <Information Processing Method 3>

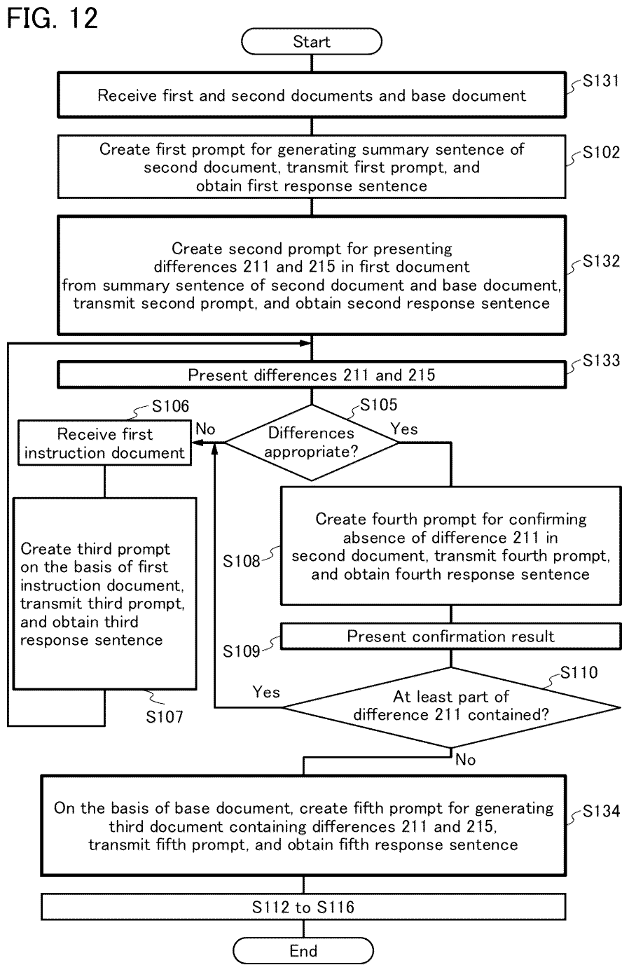

FIG. 12 is a flow diagram showing an example of the information processing method of one embodiment of the present invention, which is different from that in FIG. 3 and FIG. 4. In FIG. 12, steps not performed in the information processing method shown in FIG. 3 and FIG. 4 are shown in thick frames.

When the information processing method of one embodiment of the present invention “starts”, the reception unit 110 receives a base document as well as the first and second documents in Step S131. The base document is a document on the basis of which the third document is generated.

The base document is a document in which a creation related to the first document is described. The base document is preferably a literature that has not yet been published. The base document can be, for example, a specification belonging to one's patent application or utility model registration application that has not yet been published. Note that the base document may be an application document belonging to one's design registration application that has not yet been published. The base document may be a paper, a book, a journal, or the like. The base document can be a document stored in a database, for example.

Note that the reception unit 110 may receive a plurality of base documents. In this case, the third document can be generated in a later step on the basis of a commonality among the plurality of base documents, for example. Thus, in the case where the base document is a specification belonging to a patent application, for example, the explanation of a structure that is the main concept of the invention related to the patent application can be inhibited from being included in the third document.

Next, Step S102 is performed. After that, in Step S132, the processing unit 130 creates the second prompt and transmits it to the information processing device 40 through the output unit 140. Specifically, as in Step S103 in FIG. 3, the second prompt is transmitted to the difference presentation language model of the information processing device 40. In Step S132, the second prompt is a prompt for presenting a difference in the first document from the summary sentence of the second document and a difference in the first document from the base document.

The second prompt in Step S132 includes the base document as well as the first document and the summary sentence of the second document. The second prompt in Step S132 also includes order sentences such as “Among features described in the input document, present a feature not described in the base document as a difference from the base document. Present a feature not described in any of summary sentences of literatures as a difference from the literature. Present the difference in bullet points.”

The information processing device 40 generates the second response sentence on the basis of the second prompt with use of the difference presentation language model and supplies the second response sentence to the reception unit 110. In such a manner, the information processing device 10 obtains the second response sentence. The second response sentence includes a difference in the first document from the summary sentence of the second document and a difference in the first document from the base document. Here, when including a plurality of base documents, the second prompt in Step S132 can be a prompt for presenting a feature not described in any of the base documents as a difference. Note that the information processing system of one embodiment of the present invention may perform Step S103 instead of Step S132. That is, also in the information processing method shown in FIG. 12, the information processing system does not necessarily present a difference in the first document from the base document.

Next, in Step S133, the processing unit 130 presents, to the user of the information processing system, the above-described differences presented by the difference presentation language model. That is, the processing unit 130 presents, to the user of the information processing system, the difference 211 from the summary sentence of the second document and a difference 215 from the base document in the first document. In such a manner, the processing unit 130 makes the user determine whether the differences are appropriate. As in Step S104 in FIG. 3, the processing unit 130 creates data including the contents shown by the second response sentence and supplies the data to the information terminal 20 through the output unit 140, for example. Thus, the above-described differences are displayed on the display portion of the information terminal 20.

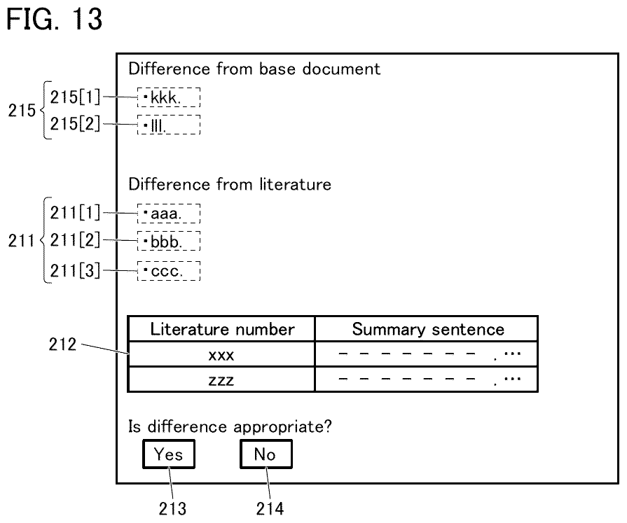

FIG. 13 shows an example of information displayed on the display portion of the information terminal 20 in Step S133. In the example shown in FIG. 13, the difference 215 from the base document is shown as well as the difference 211 from the literature (second document) shown in FIG. 6A, the table 212 that lists the second documents, the button 213 selected when the difference is appropriate, and the button 214 selected when the difference is not appropriate. In the example shown in FIG. 13, “kkk.” and “lll.” denote the difference 215. Here, “kkk.” and “lll.” are referred to as a difference 215[1] and a difference 215[2], respectively. Note that not only a difference from the base document but also a commonality with the base document may be displayed. In this case, the second prompt is a prompt for presenting not only a difference between the first document and the base document but also a commonality therebetween. Specifically, the order sentence in the second prompt includes a text for presenting the commonality.

Next, Steps S105 to S110 are performed. Here, the first instruction document can include a comment on the difference 215. The third prompt can be a prompt for presenting a difference in the first document from the summary sentence of the second document and a difference in the first document from the base document on the basis of the contents of the first instruction document.

In the case where the second document is determined to contain at least part of the difference 211 in Step S108, the process proceeds to Step S106 from the branching point of Step S110, as in the example shown in FIG. 3. In the case where the difference 211 is determined to be absent in the second document in Step S108, the process proceeds to Step S134 from the branching point of Step S110. In Step S134, the processing unit 130 creates the fifth prompt and transmits it to the information processing device 40 through the output unit 140. Specifically, as in Step S111 in FIG. 4, the fifth prompt is transmitted to the text generation language model of the information processing device 40. The fifth prompt in Step S134 is a prompt for generating the third document containing the differences 211 and 215 on the basis of the base document.

Here, the difference 211 is, for example, a difference in the first document from a published literature. Meanwhile, the difference 215 is, for example, a difference in the first document from an unpublished literature. Thus, the fifth prompt in Step S134 is preferably a prompt for generating the third document in which the difference 211 is more emphasized than the difference 215.

The fifth prompt in Step S134 includes the base document and the difference 215 as well as the second document and the difference 211. The fifth prompt in Step S134 also includes order sentences such as “On the basis of the base document, generate a new document that includes a difference in the input document from the literature and a difference in the input document from the base document. Emphasize the difference from the literature more than the difference from the base document.” Note that the fifth prompt does not necessarily include the difference 215. For example, in the case where Step S103 is performed instead of Step S132 as described above, the fifth prompt does not include the difference 215.

The information processing device 40 generates the fifth response sentence on the basis of the fifth prompt with use of the text generation language model and supplies the fifth response sentence to the reception unit 110. In such a manner, the information processing device 10 obtains the fifth response sentence. As described above, the fifth response sentence includes the third document.

Here, in the case where the fifth prompt includes a plurality of base documents, as described above, the text generation language model can generate the third document on the basis of a commonality among the plurality of base documents, for example. Thus, in the case where the base document is a specification belonging to a patent application, for example, the explanation of a structure that is the main concept of the invention related to the patent application can be inhibited from being included in the third document.

The third document in Step S134 is generated on the basis of the base document and thus can be a document of the same kind as the base document. For example, in the case where the base document is a patent application document or a utility model application document, the third document can also be a patent application document or a utility model application document. Specifically, in the case where the base document is a specification, the third document can also be a specification.

Steps S121 to S125 shown in FIG. 10 may precede Step S134. That is, after missing information for generating the third document is added, the text generation language model may generate the third document in Step S134.

Next, Steps S112 to S116 in FIG. 4 are performed. Accordingly, the information processing method of one embodiment of the present invention “ends”.

As described above, in the information processing method shown in FIG. 12 and FIG. 13, the third document can be generated on the basis of the base document. Accordingly, for example, the third document can be generated to include a commonality with one's application. In addition, the expression or the like in the text in the third document can be inhibited from being similar to those in others' literatures. Thus, the highly complete third document can be prepared.

Moreover, as the third document, a different type of document from the second document can be generated. For example, with use of a patent literature or a utility model literature as the base document, a specification belonging to a patent application or a utility model registration application can be generated as the third document even when at least part of the second document is a paper, a book, a journal, or the like. Furthermore, by generating the third document that includes a difference in the first document from the base document, a larger number of structures can be covered by any of one's applications, for example. Thus, a comprehensive rights portfolio, e.g., a comprehensive patent portfolio, can be easily built.

Accordingly, an information processing device, an information processing method, and an information processing system that are highly convenient and useful can be provided.

### <Structure Example 2 of Information Processing System>

A detailed structure example of the information processing system of one embodiment of the present invention is described below. Specifically, structure examples of the memory unit 120, the processing unit 130, and the network 30 that are not shown in <Structure example 1 of information processing system> are described.

The memory unit 120 includes at least one of a volatile memory and a nonvolatile memory. Examples of the volatile memory include a dynamic random-access memory (DRAM) and a static random-access memory (SRAM). Examples of the nonvolatile memory include a resistive random-access memory (ReRAM, also referred to as a resistance-change memory), a phase-change random-access memory (PRAM), a ferroelectric random-access memory (FeRAM), a magnetoresistive random-access memory (MRAM, also referred to as a magnetoresistive memory), and a flash memory. The memory unit 120 may include at least one of a NOSRAM (registered trademark) and a DOSRAM (registered trademark). The memory unit 120 may include a recording media drive. Examples of the recording media drive include a hard disk drive (HDD) and a solid-state drive (SSD).

Note that “NOSRAM” is an abbreviation for a nonvolatile oxide semiconductor random-access memory. A NOSRAM is a memory in which a memory cell is a 2-transistor (2T) or 3-transistor (3T) gain cell and a transistor using a metal oxide in a channel formation region (also referred to as an OS transistor) is used. An OS transistor has an extremely low current that flows between a source and a drain in an off state, that is, an extremely low leakage current. The NOSRAM can be used as a nonvolatile memory by retaining electric charge corresponding to data in a memory cell, using characteristics of extremely low leakage current. In particular, the NOSRAM is capable of reading retained data without destruction (non-destructive reading), and thus is suitable for arithmetic processing in which only a data reading operation is repeated many times. The NOSRAM can have large data capacity when stacked in layers; hence, a semiconductor device in which the NOSRAM is used for a large-scale cache memory, a large-scale main memory, a large-scale storage memory, or the like can have higher performance.

The DOSRAM is an abbreviation for dynamic oxide semiconductor RAM, which indicates a RAM including one transistor (1T) and one capacitor (1C). The DOSRAM is a DRAM formed using an OS transistor, and a memory that temporarily stores data sent from the outside. The DOSRAM is a memory utilizing a low off-state current of the OS transistor.

In this specification and the like, a metal oxide means an oxide of metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In), and for example, indium oxide is preferably used. When the metal oxide included in the channel formation region is a metal oxide containing indium, the carrier mobility (electron mobility) of the OS transistor is high. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element Mis, for example, an element that has high bonding energy with oxygen. The element Mis, for example, an element that has higher bonding energy with oxygen than indium does. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide included in the channel formation region may be, for example, a metal oxide that does not contain indium and contains any of zinc, gallium, and tin, e.g., zinc tin oxide and gallium tin oxide.

The processing unit 130 can include an arithmetic circuit, for example. The processing unit 130 can include, for example, a central processing unit (CPU). The processing unit 130 can include a graphics processing unit (GPU).

The processing unit 130 may include a microprocessor such as a digital signal processor (DSP). The microprocessor may be configured with a programmable logic device (PLD) such as a field programmable gate array (FPGA) or a field programmable analog array (FPAA). The processing unit 130 may include a quantum processor. The processing unit 130 can interpret and execute instructions from programs to process various kinds of data and control programs. The programs to be executed by the processor are stored in at least one of the memory unit 120 and a memory region of the processor.

The processing unit 130 may include a main memory. The main memory includes at least one of a volatile memory such as a random access memory (RAM) and a nonvolatile memory such as a read only memory (ROM). The main memory may include at least one of the above-described NOSRAM and DOSRAM.

Examples of the RAM include a DRAM and an SRAM; a virtual memory space is assigned and utilized as a working space of the processing unit 130. An operating system, an application program, a program module, program data, a look-up table, and the like which are stored in the memory unit 120 are loaded into the RAM for execution. The data, program, and program module which are loaded into the RAM are each directly accessed and operated by the processing unit 130.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 130 can include one or both of an OS transistor and a transistor including silicon in its channel formation region (a Si transistor).

The processing unit 130 preferably includes an OS transistor. The OS transistor has an extremely low off-state current; therefore, with use of the OS transistor as a switch for retaining electric charge (data) that has flowed into a capacitor functioning as a memory element, a long data retention period can be obtained. When at least one of a register and a cache memory included in the processing unit 130 has such a feature, the processing unit 130 can be operated only when needed, and otherwise can be off while data processed immediately before turning off the processing unit 130 is stored in the memory element. In other words, normally-off computing is possible and the power consumption of the information processing system can be reduced.

As the network 30, the Internet, which is a global network and works as the infrastructure of the World Wide Web (WWW), can be used, for example. Moreover, a local network can be used as the network 30. An intranet or an extranet can be used as the network 30. A network such as a personal area network (PAN), a local area network (LAN), a campus area network (CAN), a metropolitan area network (MAN), a wide area network (WAN), or a global area network (GAN) can be used as the network 30.

In the case where a service provider using the information processing method of one embodiment of the present invention and the user who enjoys the service belong to the same organization such as a company, data transmission and reception between the information terminal 20 and the information processing device 10 is preferably performed using a network constructed in the organization, for example. Thus, data can be transmitted and received between the information terminal 20 and the information processing device 10 more safely than in the case where data is transmitted via the Internet. Furthermore, leakage of confidential information in the organization to the outside can be prevented.

Note that as communication protocols or communication technology for wireless communication, it is possible to use communication standards such as the fourth-generation mobile communication system (4G), the fifth-generation mobile communication system (5G), or the sixth-generation mobile communication system (6G); or communication standards developed by the Institute of Electrical and Electronics Engineers (IEEE), such as Wi-Fi (registered trademark) or Bluetooth (registered trademark).

### EXAMPLE

In this example, the results of performing fine-tuning on language models and evaluating them will be described.

In this example, Models A, B, C, D, and E were prepared as language models. Models A, B, C, D, and E were each Llama3.1 8B. Model A was not fine-tuned. Models B, C, D, and E were fine-tuned. For the fine-tuning, rag-dataset-12000 was used as a data set. Note that rag-dataset-12000 includes a data point including an order sentence, a context, and a response sentence. The order sentence represents a question. The fine-tuning was performed using parameter-efficient fine-tuning (PEFT). In this example, low-rank adaptation (LoRA) was employed for PEFT. LoRA is a method for updating a parameter in a language model with use of a low-level matrix. In the case of employing LoRA, the number of parameters to be updated can be smaller than in the case of not employing LoRA.

In this example, first, second, third, and fourth data sets were prepared on the basis of rag-dataset-12000. As a data point of the first data set, the data point of rag-dataset-12000 was used as is.

As a data point of the second data set, a data point obtained by omitting the context from the data point of rag-dataset-12000 was used. That is, the data point of the second data set included the order sentence and the response sentence but did not include the context.

As a data point of the third data set, a data point obtained by adding noise contexts to the data point of rag-dataset-12000 was used. Contexts used as the noise contexts were randomly extracted from rag-dataset-12000. Here, the contexts used as the noise contexts were extracted so that in each data point, the noise context was not the same as the context included in the data point. The noise context included in the data point was a context not related to the order sentence included in the data point. Thus, the third data set included the order sentence, the context, the noise context, and the response sentence. Note that in the third data set, the data points included different noise contexts.

The fourth data set included first and second data points. Like the data point of the first data set, the first data point in this example was the data point of rag-dataset-12000 as is. Moreover, the second data point in this example included the above-described noise context instead of the context of rag-dataset-12000 and included a response sentence, which was a phrase “This question cannot be answered.” (a rejection answer, which is also referred to as non-answer). In the fourth data set, the first data points and the second data points respectively accounted for 80% and 20% of the data points. That is, the fourth data set was a data set obtained by replacing the context with the noise context and using a rejection answer as the response sentence in 20% of the data points of the first data set.

In the fine-tuning of Models B to E, hyperparameter optimization (HPO) was performed. Hyperparameters selected to be optimized were the optimization algorithm (optimizer), the learning rate (LR), the number of epochs, the batch size, and the rank of a low-rank matrix in LoRA (the rank is also referred to as the LoRA rank). For the hyperparameter optimization, 9598 of the 12000 data points of rag-dataset-12000 were used.

Table 1 lists hyperparameter search spaces. Table 2 lists values of the optimized hyperparameters in Models B to E. In the hyperparameter optimization, the hyperparameters were optimized within the search spaces listed in Table 1.

TABLE 1

| Hyperparameter | Search space |
|---|---|
| Optimization algorithm | AdamW, Adafactor |
| Learning rate | 1 × 10⁻⁶ or more and 1 × 10⁻¹ or less |
| Batch size | 2ⁱ (i is an integer of 4 or more and 8 or less) |
| Number of epochs | 1 or more and 4 or less |
| LoRA rank | 2^{j} (j is an integer of 3 or more and 5 or less) |

TABLE 2

| Language | Optimization | | Batch | Number | LORA |
|---|---|---|---|---|---|
| model | algorithm | Learning rate | size | of epochs | rank |
| B | AdamW | 2.9792 × 10⁻⁴ | 32 | 2 | 8 |
| C | AdamW | 9.0499 × 10⁻⁵ | 16 | 2 | 8 |
| D | AdamW | 3.1809 × 10⁻⁵ | 16 | 3 | 16 |
| E | AdamW | 4.7055 × 10⁻⁴ | 32 | 2 | 8 |

Note that the number of warmup steps (Warmup-step) and the batch size per device in learning (per_device_train_batch_size) are hyperparameters that were not optimized. For each of Models B to E, the number of warmup steps was 10 and the batch size per device in learning was 1.

After the hyperparameter optimization, Models B to E were subjected to learning and evaluation using 10-fold cross validation (CV). In the 10-fold cross validation, 11997 of the 12000 data points of rag-dataset-12000 were divided into first to tenth data point groups. Then, learning was performed using the first to ninth data point groups as learning data, and evaluation was performed using the tenth data point group as evaluation data. Next, learning was performed using the first to eighth and tenth data point groups as learning data, and evaluation was performed using the ninth data point group as evaluation data. Learning and evaluation were sequentially performed in such a manner; lastly, learning was performed using the second to tenth data point groups as learning data, and evaluation was performed using the first data point group as evaluation data. Here, Model A, which was not fine-tuned as described above, was evaluated using the tenth data point group as evaluation data and then evaluated using the ninth data point group to the first data point group in this order as evaluation data. Accordingly, Models A to E were each evaluated 10 times.

The data point group used for learning of Model B was the first data set. The data point group used for learning of Model C was the second data set; that is, the context was omitted. The data point group used for learning of Model D was the third data set; that is, the noise context was added. The data point group used for learning of Model E was the fourth data set; that is, the context was replaced with the noise context and a rejection answer was used as the response sentence in 20% of the data points. Models B to E were subjected to supervised learning using the response sentence as a label.

The evaluated items were context recall (CR), precision (P), and negative rejection (NR).

The context recall refers to a value obtained by dividing the number of tokens included in both the response sentence included in the above evaluation data (this sentence is also referred to as a golden answer) and a response sentence generated when the evaluation data is input to each model (this sentence is also referred to as a generated answer) by the total number of tokens included in the generated answer. The precision refers to a value obtained by dividing the number of tokens included in both the context included in the above evaluation data and the generated answer by the total number of tokens included in the generated answer. Here, as each of the data point used for evaluating the context recall and the data point used for evaluating the precision, the data point of rag-dataset-12000 was used as is. That is, omission of the context, addition of the noise context, or the like was not performed with respect to the data point group used as the evaluation data for evaluation of any of Models A to E.

The negative rejection was evaluated using data obtained by randomly interchanging the contexts of the data points included in the above evaluation data. This data is referred to as data for NR evaluation. In the data for NR evaluation, a golden answer was a rejection answer. The negative rejection refers to a proportion of the case where a response sentence generated when the data for NR evaluation is input to each model is a rejection answer, which is a golden answer.

The above indicates that hallucination is less likely to occur in the model with the higher context recall, precision, and negative rejection.

Table 3 lists the context recall (CR) of Models A to E, Table 4 lists the precision (P) thereof, and Table 5 lists the negative rejection (NR) thereof. In this example, the context recall, precision, and negative rejection of the language models were each evaluated 10 times in the above-described manner. Tables 3 to 5 each list the macro averages of the 10 times of evaluations and the 95% confidence intervals calculated on the basis of the 10 times of evaluations.

TABLE 3

| Language model | Context recall (%) |
|---|---|
| A | 67.2 ± 0.4 |
| B | 80.9 ± 0.7 |
| C | 76.6 ± 0.6 |
| D | 80.7 ± 0.4 |
| E | 79.9 ± 0.6 |

TABLE 4

| Language model | Precision (%) |
|---|---|
| A | 80.6 ± 0.2 |
| B | 88.8 ± 0.2 |
| C | 88.0 ± 0.2 |
| D | 88.6 ± 0.2 |
| E | 88.9 ± 0.1 |

TABLE 5

| Language model | NR (%) |
|---|---|
| A | 99.3 ± 0.1 |
| B | 0.4 ± 0.3 |
| C | 0.0 ± 0.0 |
| D | 13.8 ± 2.4 |
| E | 99.6 ± 0.1 |

Tables 3 and 4 confirm that Models B to E that were fine-tuned each had higher context recall and precision than Model A that was not fine-tuned. Meanwhile, Model C that was fine-tuned without the context had lower context recall and precision than Model B that was fine-tuned with the context. These suggest that Llama3.1 8B, which is a language model, can perform learning on the basis of the context.

Moreover, Tables 3 and 4 confirm that Model D including the noise context had context recall and precision equivalent to those of Model B not including the noise context. This is probably because the hyperparameter optimization was performed in the fine-tuning.

Table 5 confirms that Models B, C, and D each had significantly lower negative rejection than Model A. This is probably because overtraining occurred in Models B, C, and D. Meanwhile, Tables 3 to 5 confirm that Model E in which some of the contexts were replaced with the noise contexts and some of the response sentences were rejection answers had context recall and precision equivalent to those of Model B and had negative rejection equivalent to that of Model A. The above proves that in the case of performing fine-tuning using rejection answers as some of labels, a reduction in negative rejection can be prevented while context recall and precision are improved as compared with the case of not performing fine-tuning.

The second, fourth, and sixth learning response sentences in the above embodiment each correspond to the rejection answer in this example. This suggests that in the above embodiment, a difference presentation language model in which occurrence of hallucination is inhibited can be provided by performing fine-tuning using the second and fourth data points. This also suggests that a missing information presentation language model in which occurrence of hallucination is inhibited can be provided by performing fine-tuning using the sixth data point.

This application is based on Japanese Patent Application Serial No. 2025-036025 filed with Japan Patent Office on Mar. 7, 2025, the entire contents of which are hereby incorporated by reference.

What is claimed is:

1. An information processing method comprising:
receiving a first document and a second document;
obtaining a summary sentence of the second document with use of a first language model; and
obtaining a difference in the first document from the summary sentence with use of a second language model,
wherein the second language model is learned using a first data point and a second data point,
wherein the first data point comprises a first order sentence, a first learning text, a second learning text, and a first learning response sentence,
wherein the second data point comprises the first order sentence, a third learning text, a fourth learning text, and a second learning response sentence,
wherein the first learning response sentence shows a difference in the first learning text from the second learning text, and
wherein the second learning response sentence shows absence of a difference in the third learning text from the fourth learning text.

2. The information processing method according to claim 1, further comprising:
presenting the difference from the summary sentence and receiving a determination of whether the difference from the summary sentence is appropriate;
when the difference from the summary sentence is not appropriate, receiving an instruction document, obtaining again a difference in the first document from the summary sentence on the basis of the instruction document with use of the second language model, and then receiving again a determination of whether the difference from the summary sentence is appropriate; and
when the difference from the summary sentence is appropriate, confirming absence of the difference from the summary sentence in the second document with use of the second language model,
wherein the second language model is learned using a third data point and a fourth data point,
wherein the third data point comprises a second order sentence, a fifth learning text, a sixth learning text, a first learning instruction document, and a third learning response sentence,
wherein the fourth data point comprises the second order sentence, a seventh learning text, an eighth learning text, a second learning instruction document, and a fourth learning response sentence,
wherein the third learning response sentence shows a difference in the fifth learning text from the sixth learning text, the difference being based on the first learning instruction document, and
wherein the fourth learning response sentence shows that the second learning instruction document is not appropriate as a material for determining a difference in the seventh learning text from the eighth learning text.

3. An information processing method comprising:
a first step;
a second step;
a third step;
a fourth step;
a fifth step;
a sixth step;
a seventh step;
an eighth step;
a ninth step;
a tenth step;
an eleventh step; and
a twelfth step,
wherein in the first step, a first document and a second document are received,
wherein in the second step, a first prompt for generating a summary sentence of the second document is created and transmitted to a first language model,
wherein in the third step, a second prompt for presenting a difference in the first document from the summary sentence is created and transmitted to a second language model,
wherein in the fourth step, a determination of whether the difference is appropriate is received,
wherein when the difference is not appropriate, a first instruction document is received in the fifth step, a third prompt for presenting again a difference in the first document on the basis of the first instruction document is created and transmitted to the second language model in the sixth step, and then the fourth step is performed again,
wherein when the difference is appropriate, a fourth prompt for confirming absence of the difference in the second document is created and transmitted to the second language model in the seventh step,
wherein when the second document comprises at least part of the difference, the fifth step is performed again,
wherein when the difference is absent in the second document, a fifth prompt for generating a third document on the basis of the second document and the difference is created and transmitted to the first language model in the eighth step,
wherein in the ninth step, a determination of whether the third document needs modification is received,
wherein when the modification is needed, a second instruction document is received in the tenth step, a sixth prompt for modifying the third document on the basis of the second instruction document is created and transmitted to the first language model in the eleventh step, and then the ninth step is performed again,
wherein when the modification is not needed, the third document is output in the twelfth step,
wherein the second language model is learned using a first data point and a second data point,
wherein the first data point comprises a first order sentence, a first learning text, a second learning text, and a first learning response sentence,
wherein the second data point comprises the first order sentence, a third learning text, a fourth learning text, and a second learning response sentence,
wherein the first learning response sentence shows a difference in the first learning text from the second learning text, and
wherein the second learning response sentence shows absence of a difference in the third learning text from the fourth learning text.

4. The information processing method according to claim 3,
wherein the second language model is learned using a third data point and a fourth data point,
wherein the third data point comprises a second order sentence, a fifth learning text, a sixth learning text, a first learning instruction document, and a third learning response sentence,
wherein the fourth data point comprises the second order sentence, a seventh learning text, an eighth learning text, a second learning instruction document, and a fourth learning response sentence,
wherein the third learning response sentence shows a difference in the fifth learning text from the sixth learning text, the difference being based on the first learning instruction document, and
wherein the fourth learning response sentence shows that the second learning instruction document is not appropriate as a material for determining a difference in the seventh learning text from the eighth learning text.

5. The information processing method according to claim 3,
wherein the first instruction document comprises at least one of an instruction to modify the first document and a comment on the difference from the summary sentence, and
wherein the second instruction document comprises at least one of an instruction to modify the third document and a comment on the third document.

6. The information processing method according to claim 3, further comprising:
a thirteenth step;
a fourteenth step; and
a fifteenth step,
wherein when the difference from the summary sentence is absent in the second document, before the eighth step, a seventh prompt for determining whether information for generating the third document is insufficient is created and transmitted to a third language model in the thirteenth step,
wherein when the information is insufficient, additional information is received in the fourteenth step and then the seventh prompt is created again to comprise the additional information and transmitted to the first language model in the fifteenth step,
wherein when the information is not insufficient, the eighth step is performed again,
wherein the third language model is learned using a fifth data point and a sixth data point,
wherein the fifth data point comprises a third order sentence, a ninth learning text, a tenth learning text, and a fifth learning response sentence,
wherein the sixth data point comprises the third order sentence, an eleventh learning text, a twelfth learning text, and a sixth learning response sentence,
wherein the fifth learning response sentence presents missing information for generating a document on the basis of the ninth learning text and the tenth learning text, and
wherein the sixth learning response sentence shows that information for generating a document on the basis of the eleventh learning text and the twelfth learning text is not insufficient.

7. The information processing method according to claim 3,
wherein the first document and the second document are each a document describing a creation.

8. The information processing method according to claim 7,
wherein the second document is a patent literature or a utility model literature, and
wherein the third document is a specification belonging to a patent application or a specification belonging to a utility model registration application.

9. An information processing device comprising:
a reception unit;
an output unit; and
a processing unit,
wherein the reception unit is configured to receive a first document, a second document, a first instruction document, and a second instruction document,
wherein the output unit is configured to supply a first prompt, a fifth prompt, and a sixth prompt to a first language model and supply a second prompt, a third prompt, and a fourth prompt to a second language model,
wherein the output unit is configured to output a third document,
wherein the processing unit is configured to perform:
processing of creating the first prompt for generating a summary sentence of the second document;
processing of creating the second prompt for presenting a difference in the first document from the summary sentence;
processing of making a user determine whether the difference is appropriate;
processing of, when the difference is not appropriate, creating the third prompt for presenting again a difference in the first document on the basis of the first instruction document;
processing of, when the difference is appropriate, creating the fourth prompt for confirming absence of the difference in the second document;
processing of, when the second document comprises at least part of the difference, creating the third prompt on the basis of the first instruction document;
processing of, when the difference is absent in the second document, creating the fifth prompt for generating the third document on the basis of the second document and the difference;
processing of making the user determine whether the third document needs modification; and
processing of, when the modification is needed, creating the sixth prompt for modifying the third document on the basis of the second instruction document,
wherein the second language model is learned using a first data point and a second data point,
wherein the first data point comprises a first order sentence, a first learning text, a second learning text, and a first learning response sentence,
wherein the second data point comprises the first order sentence, a third learning text, a fourth learning text, and a second learning response sentence,
wherein the first learning response sentence shows a difference in the first learning text from the second learning text, and
wherein the second learning response sentence shows absence of a difference in the third learning text from the fourth learning text.

10. The information processing device according to claim 9,
wherein the second language model is learned using a third data point and a fourth data point,
wherein the third data point comprises a second order sentence, a fifth learning text, a sixth learning text, a first learning instruction document, and a third learning response sentence,
wherein the fourth data point comprises the second order sentence, a seventh learning text, an eighth learning text, a second learning instruction document, and a fourth learning response sentence,
wherein the third learning response sentence shows a difference in the fifth learning text from the sixth learning text, the difference being based on the first learning instruction document, and
wherein the fourth learning response sentence shows that the second learning instruction document is not appropriate as a material for determining a difference in the seventh learning text from the eighth learning text.

11. The information processing device according to claim 9,
wherein the first instruction document comprises at least one of an instruction to modify the first document and a comment on the difference from the summary sentence, and
wherein the second instruction document comprises at least one of an instruction to modify the third document and a comment on the third document.

12. The information processing device according to claim 9,
wherein the reception unit is configured to receive additional information,
wherein the output unit is configured to supply a seventh prompt to a third language model,
wherein the processing unit is configured to perform:
processing of, when the difference from the summary sentence is absent in the second document, creating the seventh prompt for determining whether information for generating the third document is insufficient;
processing of, when the information is insufficient, creating again the seventh prompt so that the seventh prompt comprises the additional information; and
processing of, when the information is not insufficient, creating the fifth prompt,
wherein the third language model is learned using a fifth data point and a sixth data point,
wherein the fifth data point comprises a third order sentence, a ninth learning text, a tenth learning text, and a fifth learning response sentence,
wherein the sixth data point comprises the third order sentence, an eleventh learning text, a twelfth learning text, and a sixth learning response sentence,
wherein the fifth learning response sentence presents missing information for generating a document on the basis of the ninth learning text and the tenth learning text, and
wherein the sixth learning response sentence shows that information for generating a document on the basis of the eleventh learning text and the twelfth learning text is not insufficient.

13. The information processing device according to claim 9,
wherein the first document and the second document are each a document describing a creation.

14. The information processing device according to claim 13,
wherein the second document is a patent literature or a utility model literature, and
wherein the third document is a specification belonging to a patent application or a specification belonging to a utility model registration application.
